(19) United States
(12) Patent Application Publication
(10) Pub. No.: US 2009/0063585 A1
(43) Pub. Date: Mar. 5, 2009

(54) Using party classifiability to inform message versioning

(75) Inventors: Edward K.Y. Jung, Bellevue, WA (US); Royce A. Levien, Lexington, MA (US); Robert W. Lord, Seattle, WA (US); Mark A. Malamud, Seattle, WA (US); William Henry Mangione-Smith, Kirkland, WA (US); John D. Rinaldo, JR., Bellevue, WA (US)

Correspondence Address: Searete LLC, Suite 110, 1756-114th Ave. S.E, Bellevue, WA, 98004, US

(73) Assignee: Searete LLC, a limited liability corporation of the State of Delaware

(21) Appl. No.: 11/899,016

(22) Filed: Aug. 31, 2007

(51) Int. Cl. G06F 17/30

(52) U.S. Cl. 707/203; 707/E17.101; 707/E17.019

(57) ABSTRACT

A system, method, computer program product, and carrier are described for obtaining an indication of whether one or more parties in a region can be classified using auditory or optical data and signaling a decision of which version of a message to introduce into the region at least partly based on the indication of whether the one or more parties can be classified using the auditory or optical data.

### SUMMARY

In one aspect, a method includes but is not limited to obtaining an indication of whether one or more parties in a region can be classified using auditory or optical data and signaling a decision of which version of a message to introduce into the region at least partly based on the indication of whether the one or more parties can be classified using the auditory or optical data. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

In one aspect, a system includes but is not limited to circuitry for obtaining an indication of whether one or more parties in a region can be classified using auditory or optical data and circuitry for signaling a decision of which version of a message to introduce into the region at least partly based on the indication of whether the one or more parties can be classified using the auditory or optical data. In addition to the foregoing, other system aspects are described in the claims, drawings, and text forming a part of the present disclosure.

In addition to the foregoing, various other method and/or system and/or program product and/or physical carrier aspects are set forth and described in the teachings such as text (e.g., claims and/or detailed description) and/or drawings of the present disclosure.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 depicts an exemplary environment in which one or more technologies may be implemented.

FIG. 2 depicts a high-level logic flow of an operational process.

FIGS. 3-25 depict various environments in which one or more technologies may be implemented.

FIGS. 26-28 depict variants of the flow of FIG. 2.

### DETAILED DESCRIPTION

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In the following detailed description, reference is made to the accompanying drawings, which form a part hereof. The use of the same symbols in different drawings typically indicates similar or identical items. The illustrative embodiments described in the detailed description, drawings, and claims are not meant to be limiting. Other embodiments may be utilized, and other changes may be made, without departing from the spirit or scope of the subject matter presented here.

Following are a series of systems and flowcharts depicting implementations of processes. For ease of understanding, the flowcharts are organized such that the initial flowcharts present implementations via an initial “big picture” viewpoint and thereafter the following flowcharts present alternate implementations and/or expansions of the “big picture” flowcharts as either sub-steps or additional steps building on one or more earlier-presented flowcharts. Those having skill in the art will appreciate that the style of presentation utilized herein (e.g., beginning with a presentation of a flowchart(s) presenting an overall view and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

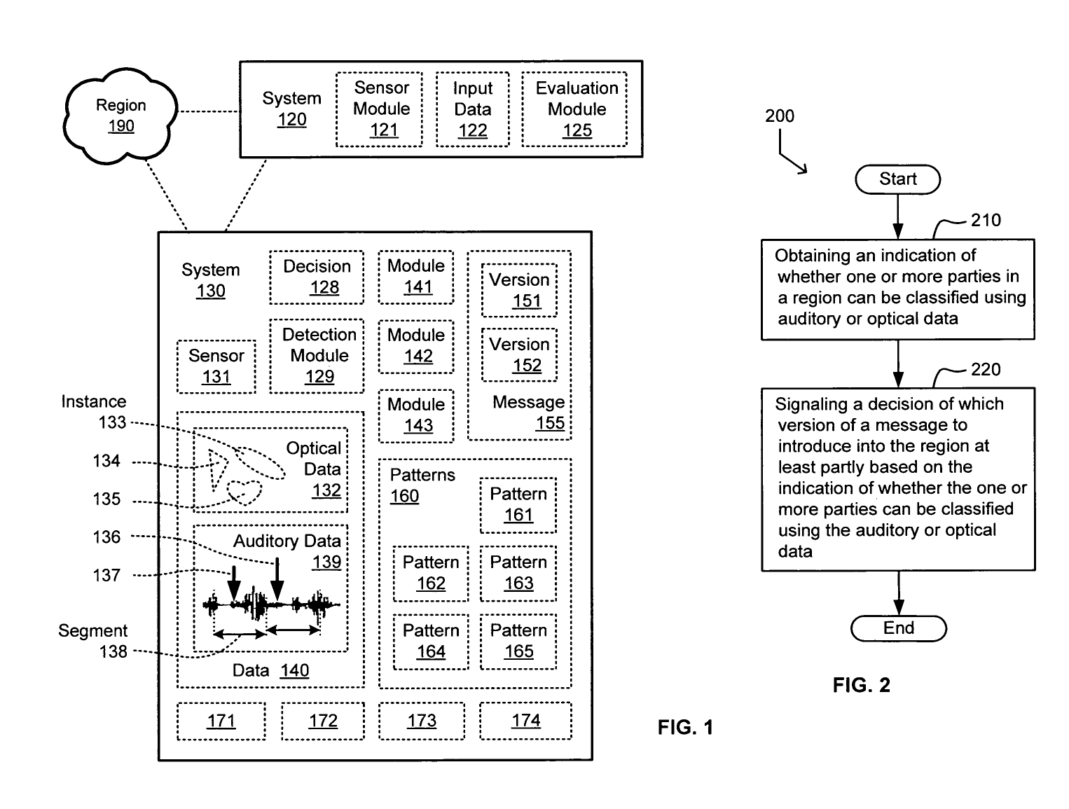

With reference now to FIG. 1, shown is an example of a system that may serve as a context for introducing one or more processes and/or devices described herein. As shown one or more systems 120, 130 may (optionally) interact with each other or with other systems or parties in region 190. System 120 may comprise one or more instances of sensor modules 121 (operable for obtaining information from or about region 190), input data 122, or evaluation modules 125. System 130 may likewise bear or otherwise include one or more instances of decisions 128, detection modules 129, sensors 131 (operable for obtaining information from or about region 190), data 140, modules 141, 142, 143, or messages 155 configured in two or more versions 151, 152. System 130 may further comprise one or more instances of models or other patterns 160, 161, 162, 163, 164, 165 of which some instances 133, 134, 135, 136, 137 may be recognized in data 140. For text or other encoded data, such patterns 160 may comprise one or more configurations of text strings, mathematical structures, proximity or logical operators or conditions, or the like. For optical data 132, such patterns 160 may comprise one or more parameters for color, brightness, distortion, timing, distance, size, or shape information such as shadowing or other optical effects. For auditory data 139, such patterns 160 may comprise one or more frequencies and/or sequences such as speech, musical structures, or other phenomena that can be recognized with existing technologies. Other such patterns 160 may comprise combinations of these such as heuristic models (e.g. for distinguishing between a person on television and a physical person, for example, such as by comparing sequential observations over time for conformity with expected behaviors of such recognizable entities).

Evaluated in this manner, one or more instances of optical data 132 may typically include one or more instances 133, 134, 135 of common or respective patterns 160. Auditory data 139 may likewise comprise one or more instances 136, 137 of common or respective patterns 160. Such data 140 may further comprise timing data such as one or more segments 138 respectively associated with one or more such instances of patterns 160. Many such patterns 161-165 may further be associated with one or more defined classifications 171, 172, 173 or default classifications 174 of individuals as described herein.

With reference now to FIG. 2, there is shown a high-level logic flow 200 of an operational process. Flow 200 includes operation 210—obtaining an indication of whether one or more parties in a region can be classified using auditory or optical data (e.g. detection module 129 invoking module 143 for receiving and evaluating whether sensor data 140 from an office, network, or other region 190 apparently includes one or more segments 138 or other instances 133-137 of classification-indicative patterns 160 at least somewhat characteristic of one or more classifications 171-173 of individuals). This can occur, for example, in a context in which such classifications include an age classification 171, a gender classification 172, or any other such classifications 173 of one or more individuals apparently in region 190. Such age classifications 171 may (optionally) be derived in response to one or more instances of self-identification or other vocal patterns 161, anatomical or other visible attribute patterns 162, specific individual recognition patterns 164, hybrid patterns 163 of optical data 132 with auditory data 139, or the like. Such gender classifications 172 may likewise be derived in response to one or more instances of self-identification or other vocal patterns 161, anatomical or other visible attribute patterns 162, specific individual recognition patterns 164, hybrid patterns 163 of optical data 132 with auditory data 139 and/or timing data, or the like.

In some variants, patterns 160 may (optionally) comprise one or more behavioral or other heuristic model patterns 165. In a context in which sensor data 140 indicates a single individual in a region of interest, for example, pattern 165 may be configured to accept a typed password or other supplemental data as sufficient for the user's self-identification. Alternatively or additionally, pattern 165 may be configured to determine whether a subject's movements are sufficiently incremental to indicate apparent continuity over time, for example, to permit a classification 173 of a person that is different from that of a projected image of a person. In a circumstance in which available data and patterns 160 indicate one or more unclassifiable parties in region 190, however, evaluation module 125 and/or detection module 129 may complete operation 210 by assigning a “miscellaneous entity” classification 174 or other negative indication. Alternatively or additionally, interaction module 142 may be operable to perform operation 210 merely by receiving such an indication from evaluation module 125, for example, or from region 190.

Flow 200 further includes operation 220—signaling a decision of which version of a message to introduce into the region at least partly based on the indication of whether the one or more parties can be classified using the auditory or optical data (e.g. interaction module 142 invoking module 141 for transmitting decision 128 into region 190 directly or via system 120). This can occur, for example, in a context in which version 151 is selected only if classification 174 was indicated. Conversely, module 141 may (optionally) be configured so that one or more versions 151 of message 155 are selected only in response to a positive indication. Alternatively or additionally, in some embodiments, interaction module 142 may perform operation 220 by presenting, recording, or otherwise transmitting some manifestation of decision 128 to a user interface or storage system of region 190. In some variants, for example, the manifestation may include the selected version(s) or some other indication(s) of which version(s) were selected. Alternatively or additionally, one or more other versions may also be transmitted, such as to facilitate faster switching among message versions in response to the indication changing. In some implementations, moreover, module 141 may be configured for presenting at least one version V152 of the message into the region in response to the decision and to one or more other events. Alternatively or additionally, module 141 may be configured for presenting a notification or other alternate version 152 into a second region under such circumstances.

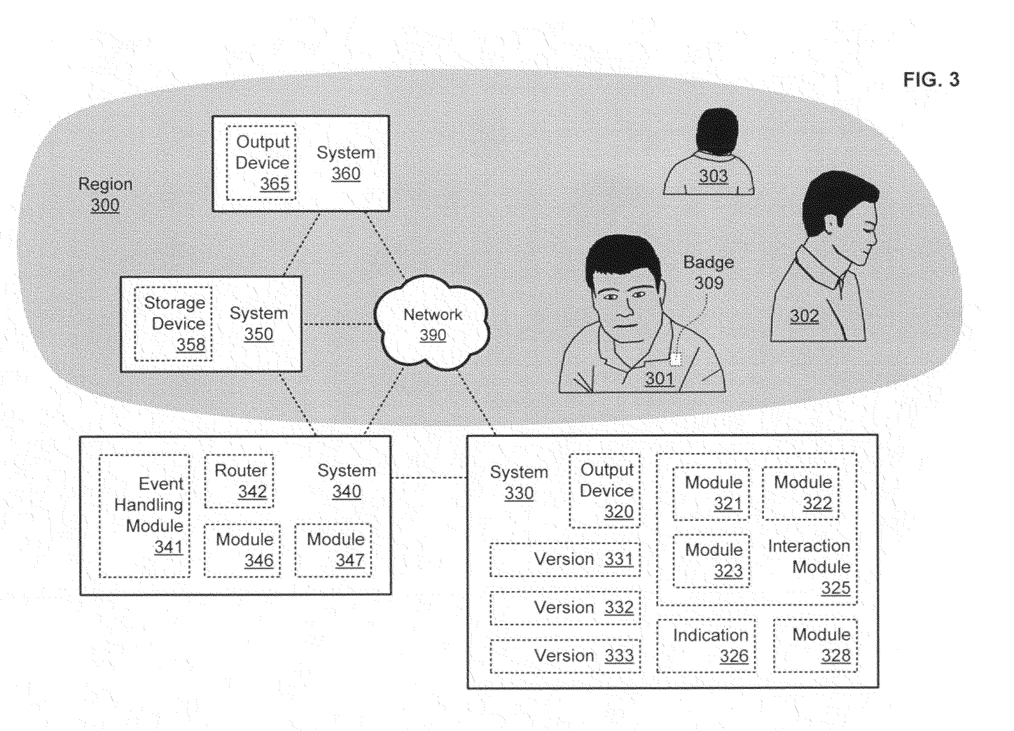

With reference now to FIG. 3, shown is another example of a system that may serve as a context for introducing one or more processes and/or devices described herein. As shown region 300 may include one or more instances of users 301, 302 or other parties 303, other recognizable objects such as badges 309, and/or one or more systems 350, 360 or networks 390 containing storage devices 358 or output devices 365 that may be accessible to one or more users 301, 302. Such systems 350, 360 or networks 390 may also be accessible by one or more other instances of systems 330, 340. System 330 may, for example, comprise one or more instances of output devices 320 (operable for communicating with one or more users 301, for example); modules 321, 322, 323, 328 such as interaction modules 325; versions 331, 332, 333 or other indications 326. System 340 may likewise comprise one or more instances of routers 342 or other modules 346, 347 such as classification modules or other event handling modules 341.

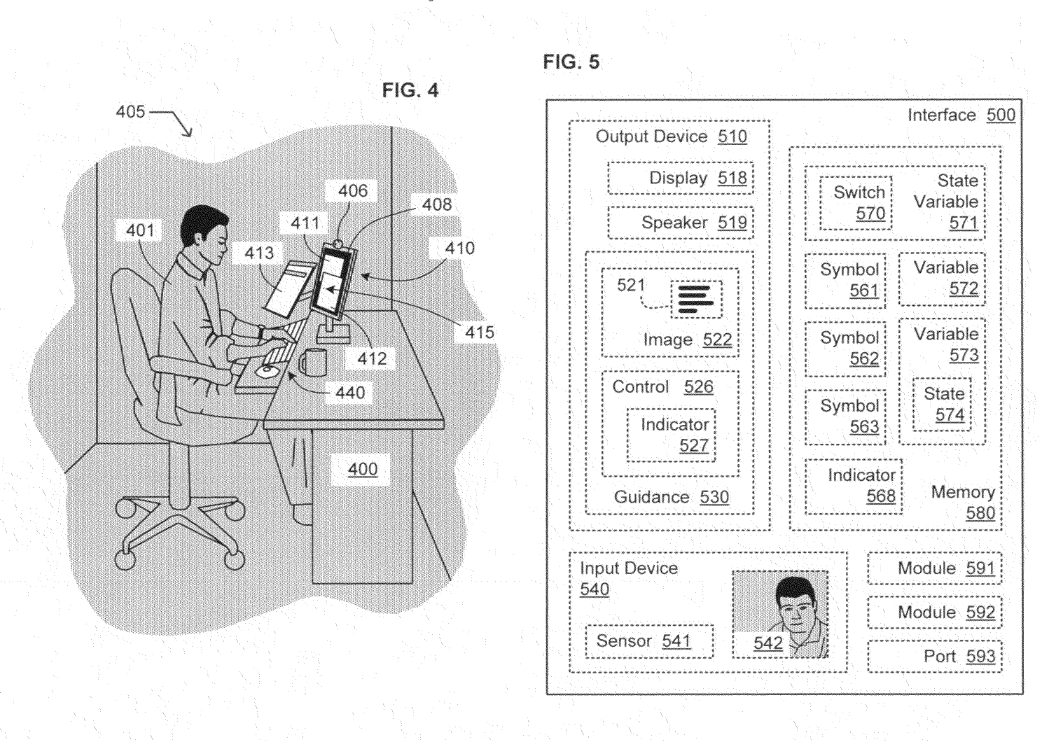

With reference now to FIG. 4, shown is another example of a system that may serve as a context for introducing one or more processes and/or devices described herein. User 401 is shown in an environment 405 of a workstation 400 comprising one or more instances of microphones, cameras, or other sensors 406; display images 408 comprising one or more shapes 415 in portions 411, 412; output devices 410; documents or other material 413; input devices 440; or the like.

With reference now to FIG. 5, shown is another example of a system that may serve as a context for introducing one or more processes and/or devices described herein. Interface 500 may represent a portion of a workstation like that of FIG. 4 schematically, and may comprise one or more instances of output devices 510, input devices 540, memories 580, modules 591, 592, or port 593. Output device 510 may comprise one or more instances of displays 518, speakers 519, text 521 or other portions of image 522, indicators 527 or other controls 526, or other guidance 530. Input device 540 may comprise one or more cameras or other sensors 541, of which some may be operable for handling streaming video or other image data signals 542. Memory 580 may include one or more instances of switches 570 or other state variables 571; symbols 561, 562, 563; variables 572, 573 such as state 574; or other indicators 568.

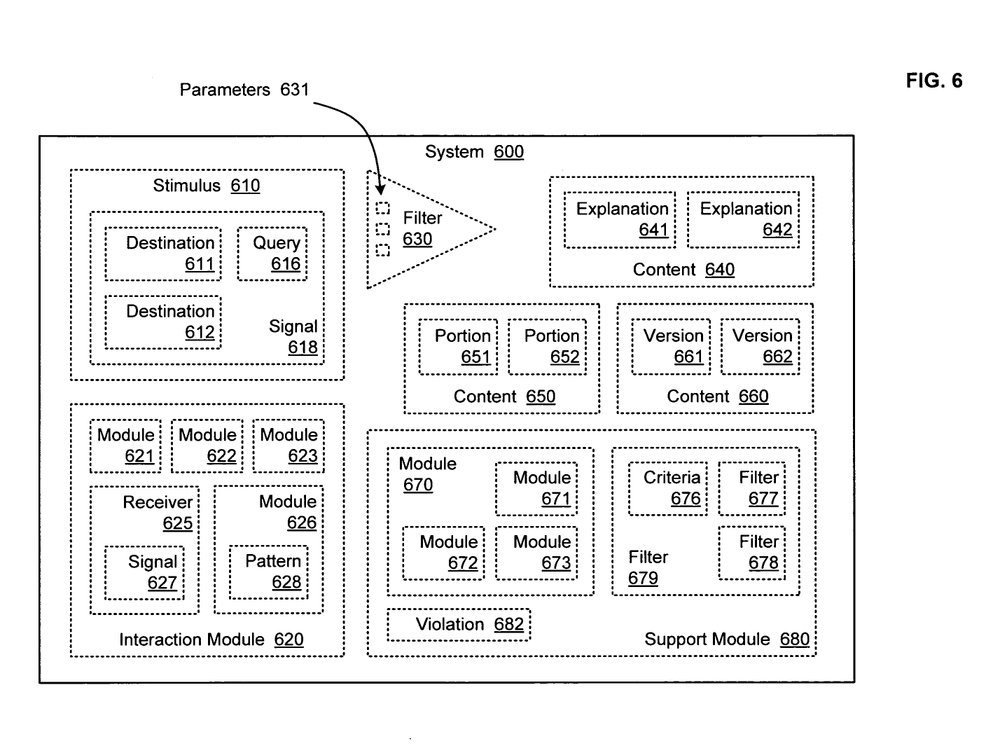

With reference now to FIG. 6, shown is another example of a system that may serve as a context for introducing one or more processes and/or devices described herein. System 600 may comprise one or more instances of stimuli 610, interaction modules 620, filters 630 (optionally with one or more parameters 631), content 640, 650, 660, or support modules 680. Stimulus 610 may comprise one or more instances of destinations 611, 612, queries 616, or other signals 618. Interaction module 620 may include one or more instances of receivers 625 (optionally operable for handling one or more signals 627) or other modules 621, 622, 623, 626 (optionally operable for handling one or more patterns 628). Content 640 may include one or more explanations 641, 642. Content 650 may include one or more portions 651, 652. Content 660 may include one or more versions 661, 662. Support module 680 may manifest or otherwise comprise one or more nested or other instances of modules 670, 671, 672, 673; implementations of one or more criteria 676 or filters 677, 678, 679; or apparent violations 682 of such criteria.

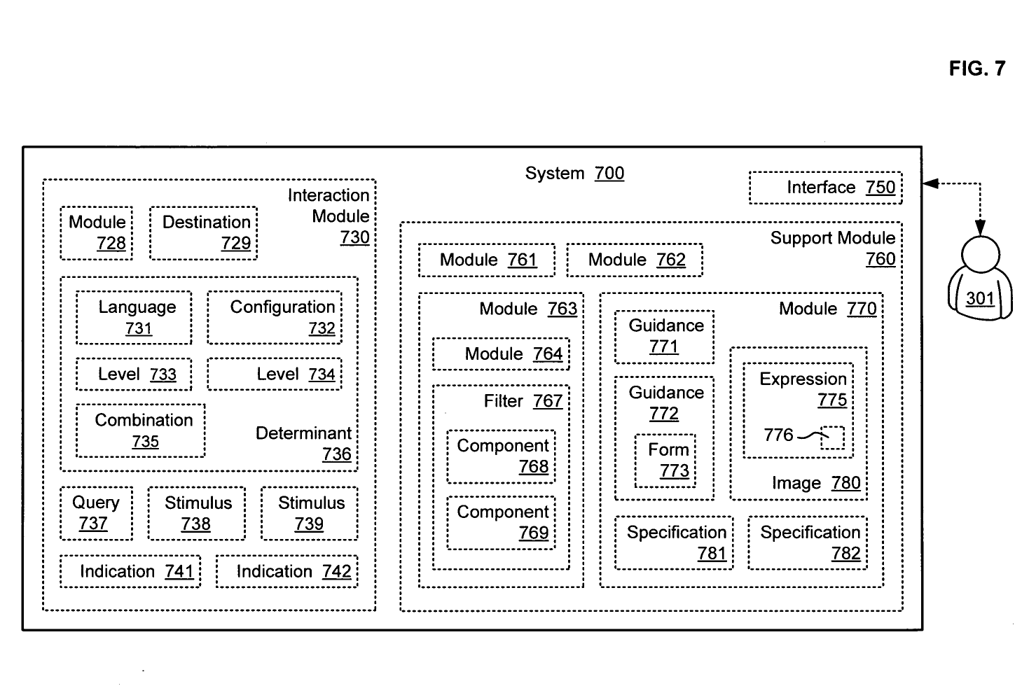

With reference now to FIG. 7, shown is another example of a system that may serve as a context for introducing one or more processes and/or devices described herein. System 700 may comprise one or more instances of interaction modules 730, interfaces 750 (accessible, for example, by user 301 of FIG. 3), or support modules 760. Interaction module 730 may comprise one or more instances of modules 728, destinations 729, determinants 736, queries 737, stimuli 738, 739 or indications 741, 742. Determinant 736 may optionally include one or more instances of (indicators of) languages 731, configurations 732, levels 733, 734, or combinations 735 of these. Support module 760 may comprise one or more instances of modules 761, 762, 763, 770. Module 763 may comprise one or more instances of nested modules 764 or filters 767 (optionally containing one or more components 768, 769). Module 770 may comprise one or more instances of guidance 771, 772 (optionally having one or more specific forms 773), images 780, or specifications 781, 782. Image 780 may comprise one or more instances of controls 776 or other expressions 775.

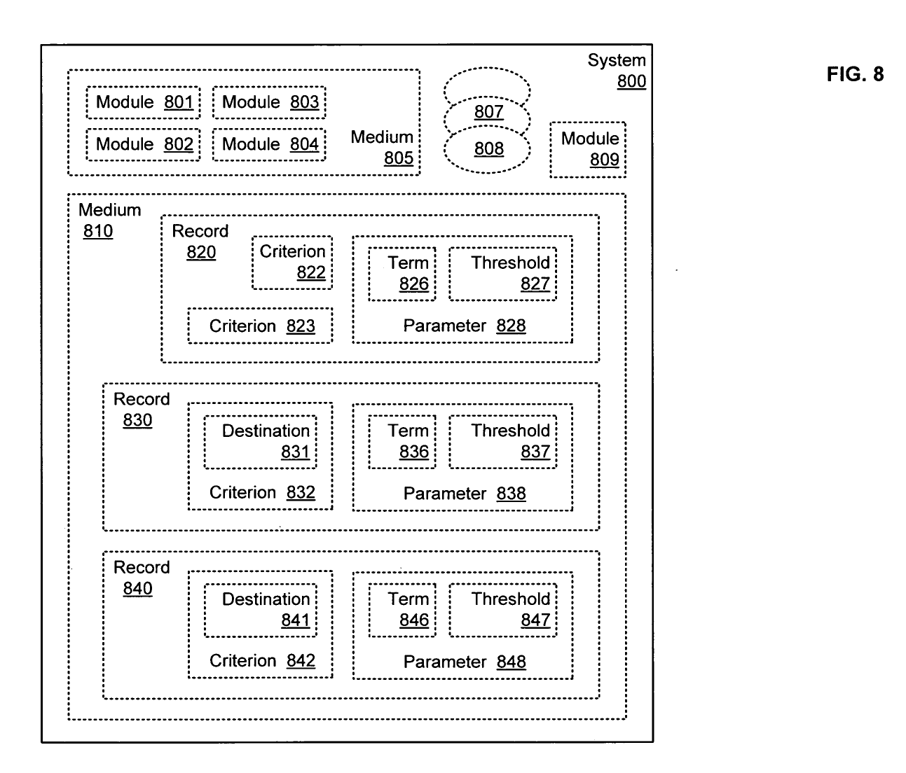

With reference now to FIG. 8, shown is another example of a system that may serve as a context for introducing one or more processes and/or devices described herein. System 800 may comprise one or more instances of content portions 807, 808 or modules 809 in various forms as well as semiconductor chips, waveguides, or storage or other media 805, 810. (In some embodiments, for example, such content or modules as described herein may include special-purpose software, special-purpose hardware, or some combination thereof, optionally in conjunction with writeable media, processors, or other general-purpose elements.) Medium 805 may, for example, comprise one or more instances of modules 801, 802, 803, 804. Medium 810 may likewise contain one or more records 820, 830, 840. Record 820 may include one or more instances of criteria 822, 823, terms 826, thresholds 827, or other parameters 828. Record 830 may similarly include one or more instances of destinations 831 or other criteria 832, terms 836, thresholds 837, or other parameters 838. Record 840 may likewise include one or more instances of destinations 841 or other criteria 842, terms 846, thresholds 847, or other parameters 848.

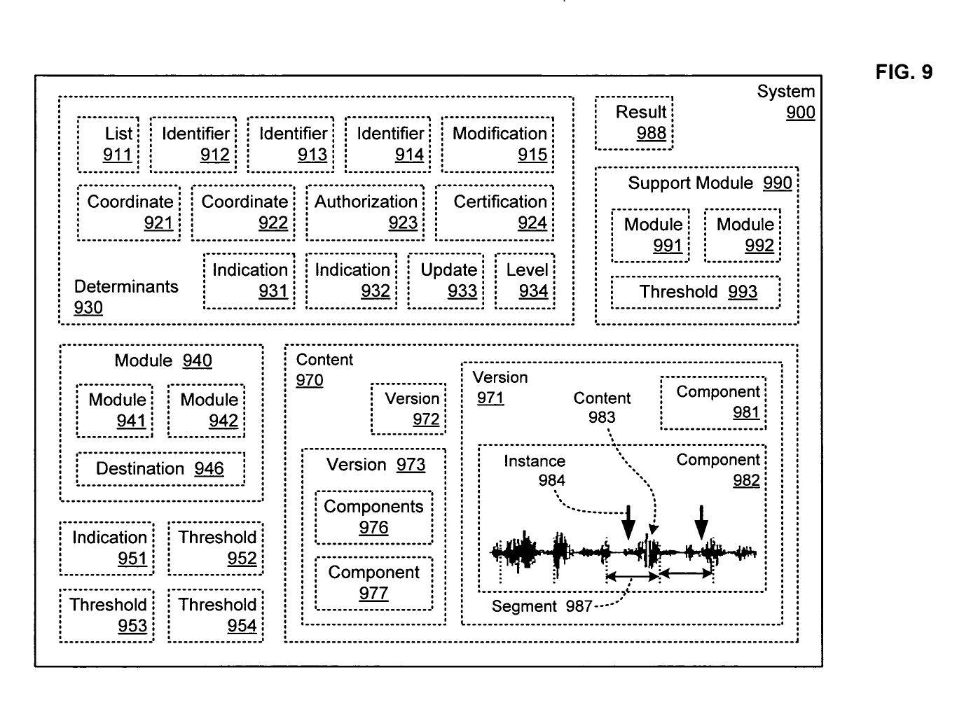

With reference now to FIG. 9, shown is another example of a system that may serve as a context for introducing one or more processes and/or devices described herein. System 900 may comprise one or more instances of determinants 930, modules 940, thresholds 952, 953, 954 or other indications 951, content 970, results 988, or support modules 990. The one or more determinants 930 may (if included) comprise one or more instances of lists 911 or other identifiers 912, 913, 914; modifications 915; coordinates 921, 922; authorizations 923; certifications 924; or updates 933, levels 934, or other indications 931, 932. Module 940 may (if included) comprise one or more instances of destinations 946 or other modules 941, 942. Content 970 may comprise one or more instances of versions 971, 972, 973 (of the same message or different messages, for example) that may each include one or more components 976, 977, 981, 982. Component 982, for example, may comprise auditory content 983 including one or more segments 987 including or overlapping one or more instances 984 of phrases or other patterns. Support module 990 may comprise one or more instances of thresholds 993 or other modules 991, 992.

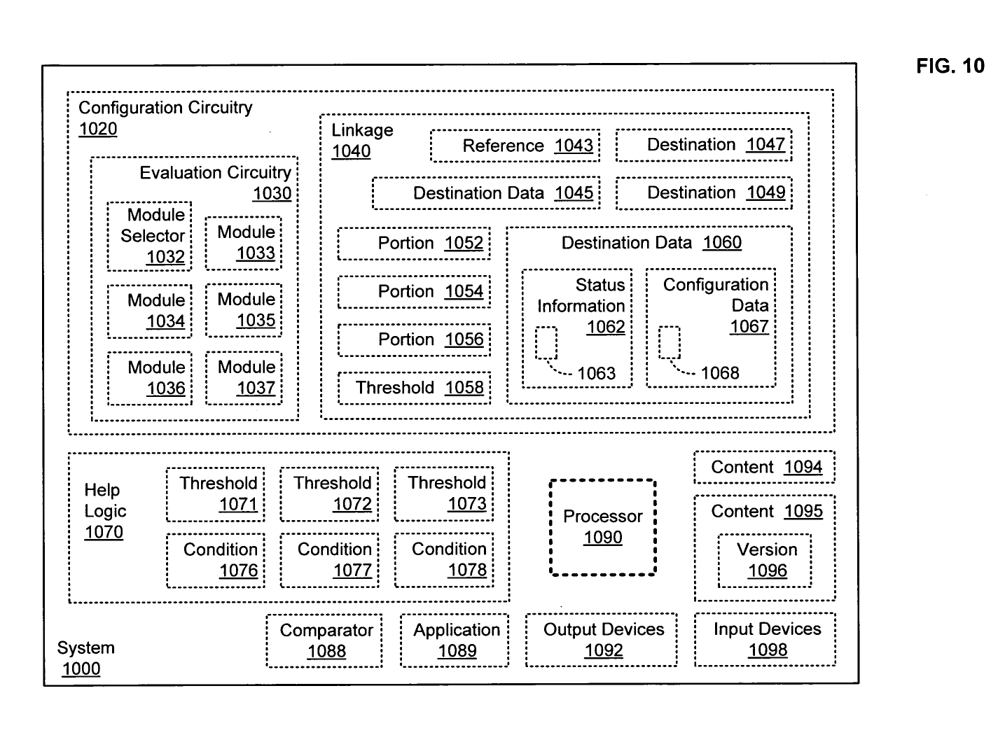

With reference now to FIG. 10, shown is another example of a system that may serve as a context for introducing one or more processes and/or devices described herein. System 1000 may comprise one or more instances of configuration circuitry 1020, help logic 1070, comparators 1088, applications 1089, processors 1090, output devices 1092, content 1094, 1095 (optionally with one or more versions 1096), or input devices 1098. Configuration circuitry 1020 may comprise one or more instances of evaluation circuitry 1030 or linkages 1040. Evaluation circuitry 1030 may comprise one or more instances of modules 1033, 1034, 1035, 1036, 1037 or module selectors 1032. Linkage 1040 may comprise one or more instances of references 1043; destination data 1045; destinations 1047, 1049; portions 1052, 1054, 1056; thresholds 1058; or destination data 1060. Destination data 1060 may comprise one or more instances of bits 1063 or other status information 1062 or of bits 1068 or other configuration data 1067. Help logic 1070 may comprise one or more thresholds 1071, 1072, 1073 or conditions 1076, 1077, 1078.

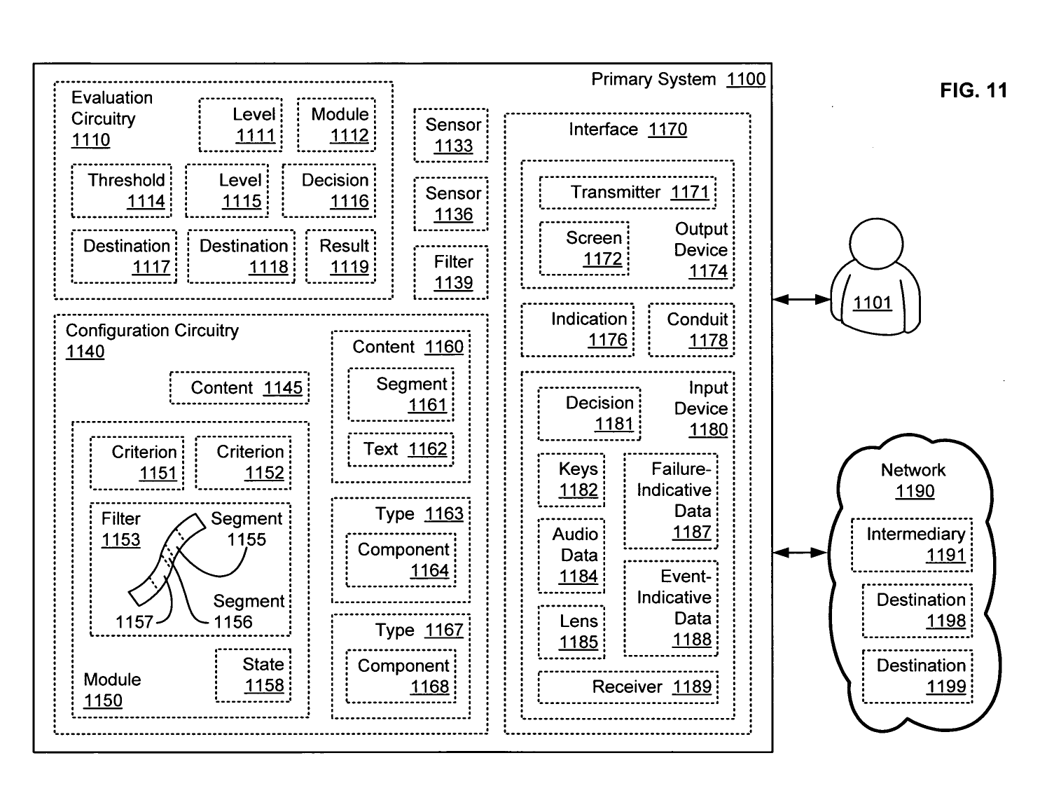

With reference now to FIG. 11, shown is another example of a system that may serve as a context for introducing one or more processes and/or devices described herein. Primary system 1100 may comprise one or more instances of evaluation circuitry 1110, sensors 1133, 1136, filters 1139, configuration circuitry 1140, or interfaces 1170 operable for interacting with one or more users 1101 or networks 1190. Evaluation circuitry 1110 may comprise one or more instances of hardware and/or software modules 1112, levels 1111, 1115, thresholds 1114, decisions 1116, destinations 1117, 1118, or results 1119. Configuration circuitry 1140 may comprise one or more instances of modules 1150; text 1162 and other segments 1161 of content 1145, 1160; and one or more components 1164, 1168 each of one or more respective types 1163, 1167. Module 1150 may comprise one or more instances of criteria 1151, 1152 such as may implement one or more filters 1153 operable on sequences of respective segments 1155, 1156, 1157 as shown, and states 1158. Interface 1170 may comprise one or more instances of output devices 1174, input devices 1180, or other conduits 1178 operable for bearing indications 1176 or the like. Output device 1174 may comprise one or more instances of transmitters 1171 or screens 1172. Input device 1180 may similarly bear or otherwise comprise one or more instances of decisions 1181, buttons or keys 1182 (of a mouse or keyboard, for example), audio data 1184, lens 1185, failure-indicative data 1187 or other event-indicative data 1188, or receivers 1189. Network 1190 may access or otherwise comprise one or more instances of intermediaries 1191 or destinations 1198, 1199.

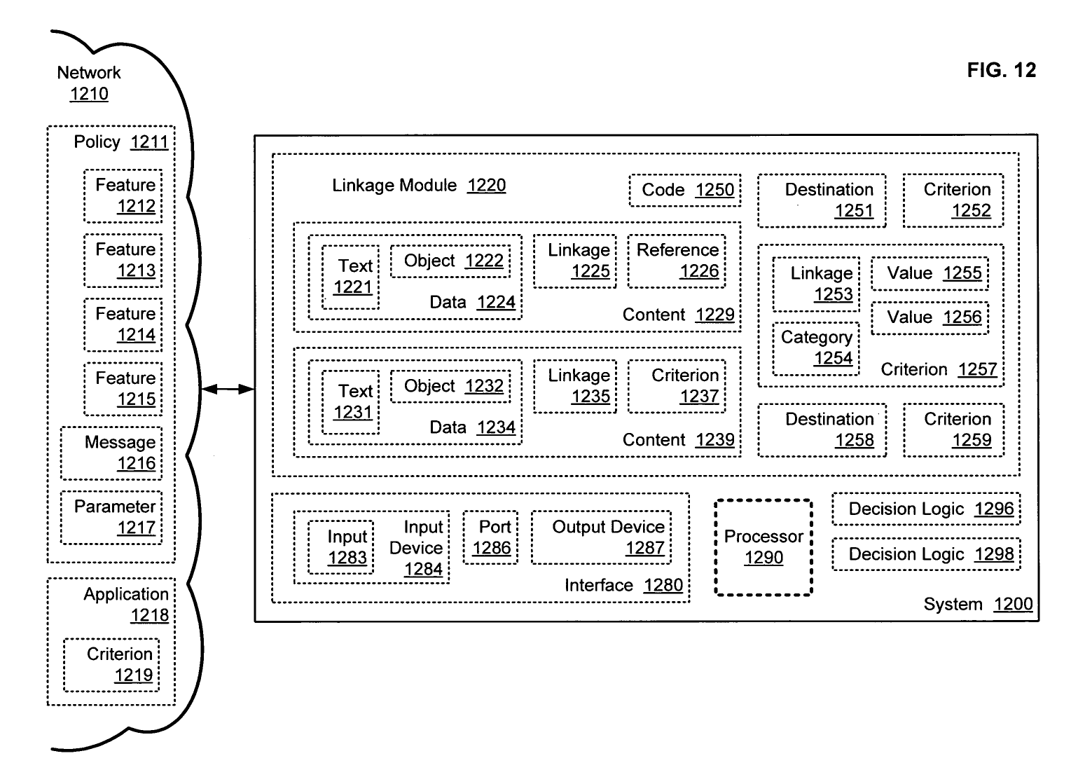

With reference now to FIG. 12, shown is another example of a system that may serve as a context for introducing one or more processes and/or devices described herein. System 1200 may operably couple with one or more networks 1210 as shown, and may comprise one or more instances of linkage modules 1220, interfaces 1280, processors 1290, or decision logic 1296, 1298. Network 1210 may comprise one or more instances of applications 1218 or other circuitry operable for implementing one or more criteria 1219 or other policies 1211. Policy 1211 may comprise one or more instances of features 1212, 1213, 1214, 1215; messages 1216; or other parameters 1217. Linkage module 1220 may comprise memory or special-purpose elements containing or otherwise comprising one or more instances of content 1229, 1239; codes 1250, destinations 1251, 1258; or criteria 1252, 1257, 1259. Content 1229 may comprise one or more instances of text 1221 or other objects 1222 of data 1224, linkages 1225, or other references 1226. Content 1239 may similarly comprise one or more instances of linkages 1235 or criteria 1237 as well as text 1231 or other objects 1232 of data 1234. Criterion 1257 may comprise one or more instances of linkages 1253, categories 1254, or other values 1255, 1256. Interface 1280 may comprise one or more instances of input 1283 (optionally borne by one or more input devices 1284), ports 1286, or output devices 1287.

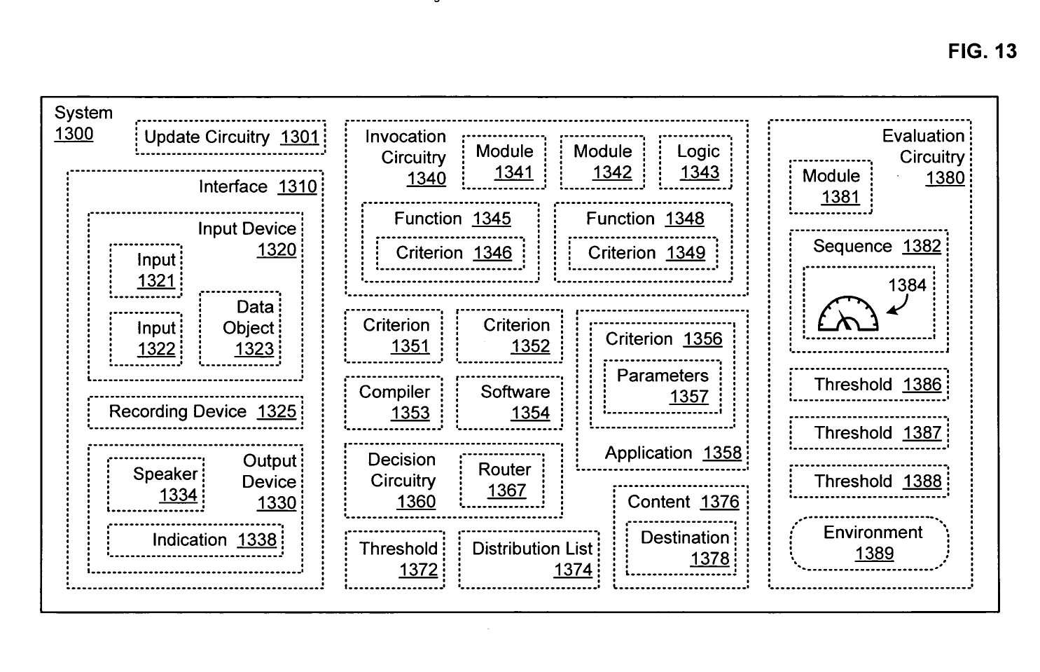

With reference now to FIG. 13, shown is another example of a system that may serve as a context for introducing one or more processes and/or devices described herein. System 1300 may comprise one or more instances of update circuitry 1301, interfaces 1310, invocation circuitry 1340, criteria 1351, 1352, compilers 1353, software 1354, applications 1358, routers 1367 or other decision circuitry 1360, thresholds 1372, distribution lists 1374, destinations 1378 or other content 1376, or evaluation circuitry 1380. Interface 1310 comprises one or more instances of input devices 1320, recording devices 1325, or output devices 1330. Input device 1320 may, for example, be operable for bearing one or more instances of inputs 1321, 1322 or other data objects 1323. One or more speakers 1334 or other output devices 1330 may similarly be operable for bearing one or more such data objects or other indications 1338. Invocation circuitry 1340 may comprise one or more instances of modules 1341, 1342, logic 1343, or functions 1345, 1348 each operable for applying one or more criteria 1346, 1349. Application 1358 may similarly comprise one or more instances of parameters 1357 operable for controlling the behavior of one or more criteria 1356. Evaluation circuitry 1380 may comprise one or more instances of modules 1381, sequences 1382 (optionally providing output 1384), thresholds 1386, 1387, 1388, or environments 1389.

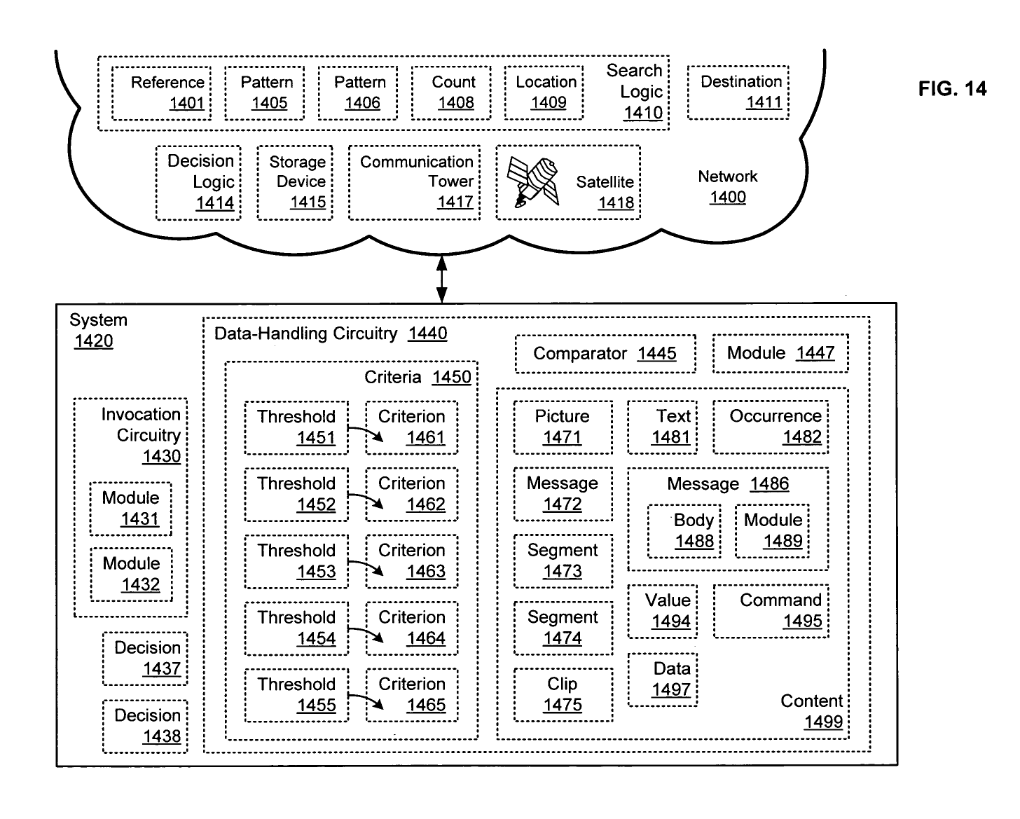

With reference now to FIG. 14, shown is another example of a system that may serve as a context for introducing one or more processes and/or devices described herein. Network 1400 may comprise one or more instances of search logic 1410, destinations 1411, decision logic 1414, storage devices 1415, communication towers 1417, or satellites 1418. Search logic 1410 may comprise one or more instances of references 1401, patterns 1405, 1406, counts 1408, or locations 1409. As shown, network 1400 may operably couple with one or more instances of system 1420, which comprises one or more instances of modules 1431, 1432 or other invocation circuitry 1430, decisions 1437, 1438, or data-handling circuitry 1440. Data-handling circuitry 1440 may comprise one or more instances of comparators 1445, modules 1447, criteria 1450, or content 1499. Such criteria 1450 may comprise one or more instances of thresholds 1451, 1452, 1453, 1454, 1455 each operable with a respective one or more criteria 1461, 1462, 1463, 1464, 1465. Content 1499 may comprise one or more instances of pictures 1471, messages 1472, segments 1473, 1474, clips 1475, text 1481 or other occurrences 1482, messages 1486, values 1494, commands 1495, or data 1497. The message(s) 1486 may comprise one or more instances of bodies 1488 or other modules 1489.

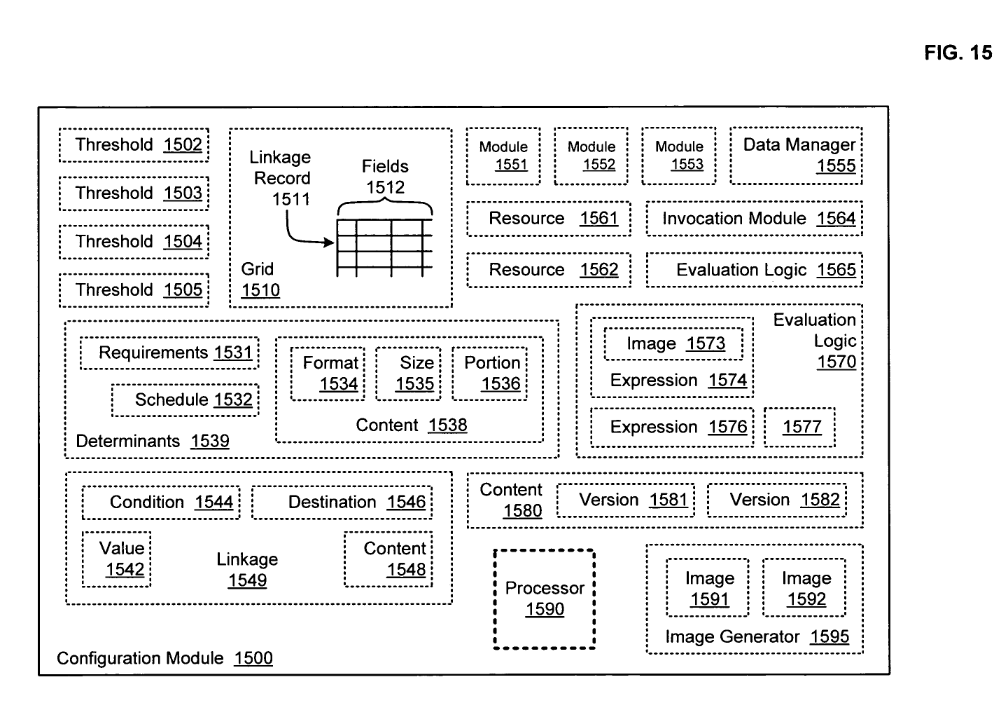

With reference now to FIG. 15, shown is another example of a system that may serve as a context for introducing one or more processes and/or devices described herein. Configuration module 1500 may include one or more instances of thresholds 1502, 1503, 1504, 1505 and/or grids 1510 or other data arrangements comprising linkage records 1511 having one or more fields 1512. Configuration module 1500 may further include one or more instances of requirements 1531, schedules 1532, content 1538, or other determinants 1539 or linkages 1549. Alternatively or additionally, configuration module 1500 may likewise include one or more instances of modules 1551, 1552, 1553; data managers 1555; resources 1561, 1562; invocation modules 1564; evaluation logic 1565, 1570; content 1580 comprising one or more versions 1581, 1582; processors 1590; or image generators 1595 operable for generating one or more images 1591, 1592. Content 1538 may comprise, implicitly or explicitly, one or more instances of formats 1534 or other portions 1536 or sizes 1535 or other aspects. Linkage 1549 may refer to or otherwise comprise one or more instances of values 1542, conditions 1544, destinations 1546, or content 1548. Evaluation logic 1570 may comprise one or more instances of images 1573 or other expressions 1574, 1576, 1577.

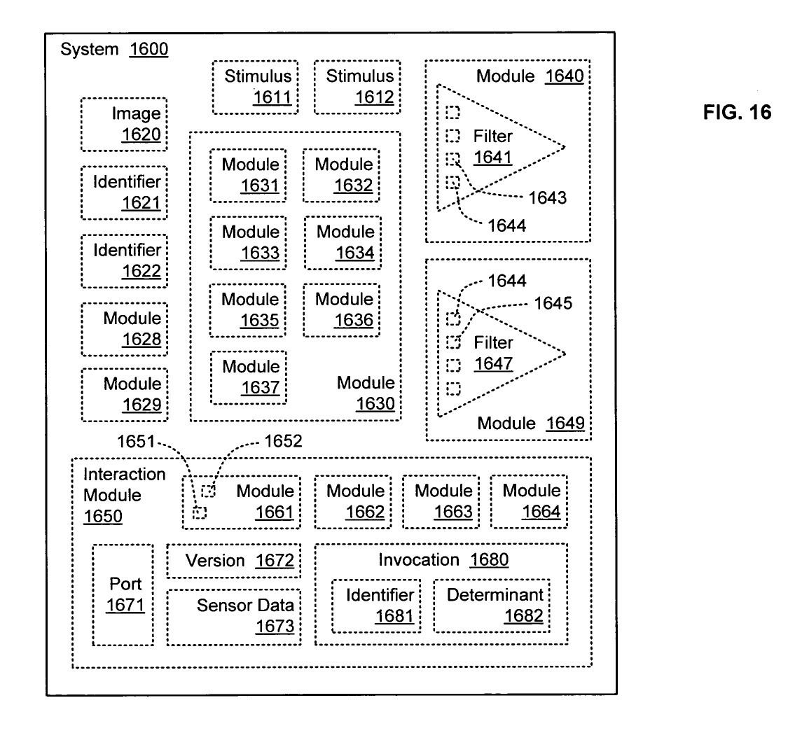

With reference now to FIG. 16, shown is another example of a system that may serve as a context for introducing one or more processes and/or devices described herein. System 1600 may include one or more instances of stimuli 1611, 1612; images 1620; identifiers 1621, 1622; or nested or other modules 1628, 1629, 1630, 1631, 1632, 1633, 1634, 1635, 1636, 1637, 1640, 1649 such as interaction module 1650. Modules 1640, 1649 may each comprise one or more instances of filters 1641, 1647 configured for applying one or more criteria 1643, 1644, 1645. Interaction module 1650 may comprise one or more instances of modules 1661, 1662, 1663, 1664 (each with one or more indications 1651, 1652, for example); ports 1671; versions 1672; sensor data 1673; or invocations 1680 (optionally comprising one or more identifiers 1681 or determinants 1682).

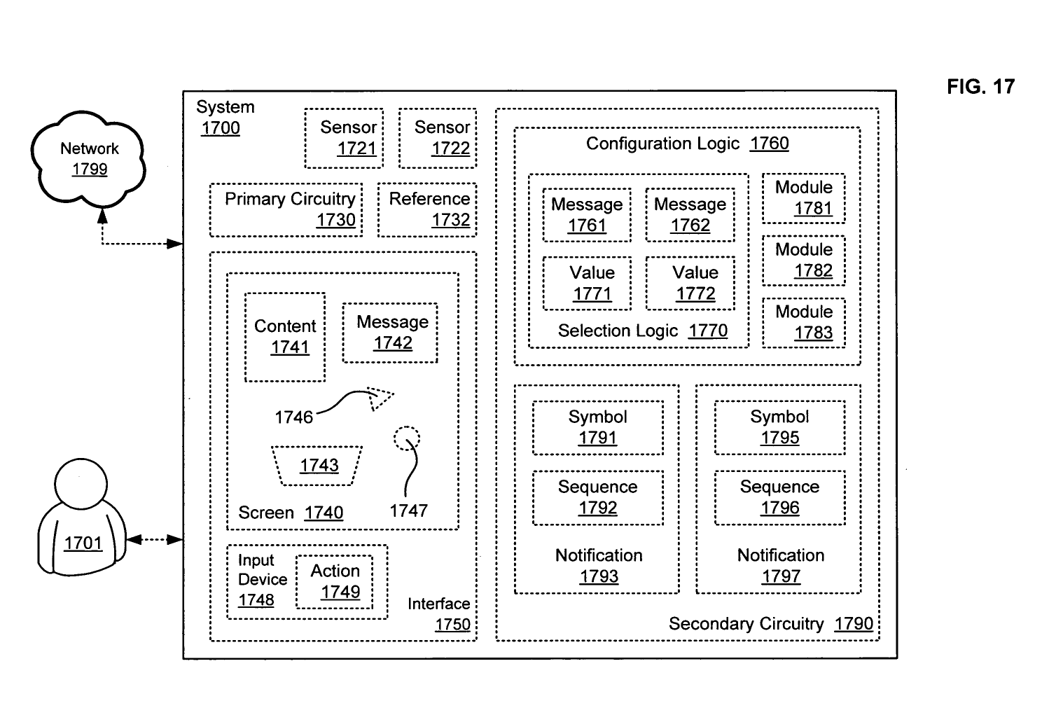

With reference now to FIG. 17, shown is another example of a system that may serve as a context for introducing one or more processes and/or devices described herein. System 1700 may include one or more instances of sensors 1721, 1722; primary circuitry 1730; references 1732; interfaces 1750; or secondary circuitry 1790; each of which may be operable for interacting with one or more users 1701 or networks 1799 as shown. Interface 1750 may include one or more instances of screens 1740, which may be operable for presenting or otherwise acting on one or more instances of messages 1742 or other content 1741, 1743 and/or on pointer 1746 or other control 1747. Alternatively or additionally, interface 1750 may include one or more input devices 1748 operable for detecting or otherwise indicating one or more user actions 1749. Secondary circuitry 1790 may comprise one or more instances of configuration logic 1760 such as selection logic 1770 or other modules 1781, 1782, 1783. Selection logic 1770 may comprise one or more instances of messages 1761, 1762 or other values 1771, 1772. Secondary circuitry may further comprise one or more notifications 1793, 1797 respectively comprising one or more symbols 1791, 1795 and/or sequences 1792, 1796.

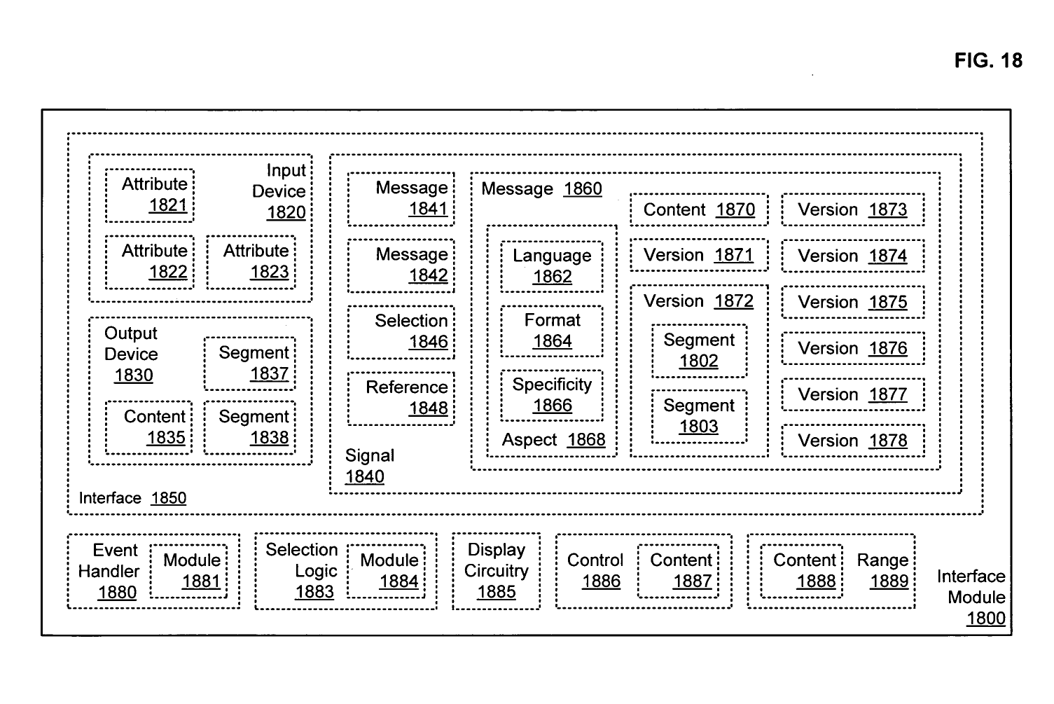

With reference now to FIG. 18, shown is another example of a system that may serve as a context for introducing one or more processes and/or devices described herein. Interface module 1800 may include one or more instances of interfaces 1850, modules 1881 of event handlers 1880, modules 1884 of selection logic 1883, display circuitry 1885, or controls 1886 or ranges 1889 that may include content 1887, 1888. Interface 1850 may include one or more instances of input devices 1820, output devices 1830, or signals 1840. Input device 1820 may detect or otherwise indicate one or more instances of attributes 1821, 1822, 1823. Output device 1830 may present or otherwise indicate one or more segments 1837, 1838 or other content 1835. Signal 1840 may comprise one or more instances of selections 1846, references 1848, or messages 1841, 1842, 1860. Message 1860 may, for example, comprise one or more instances of languages 1862, formats 1864, specificities 1866, or other aspects 1868; content 1870; or various versions 1871, 1872, 1873, 1874, 1875, 1876, 1877, 1878 each including one or more segments 1802, 1803.

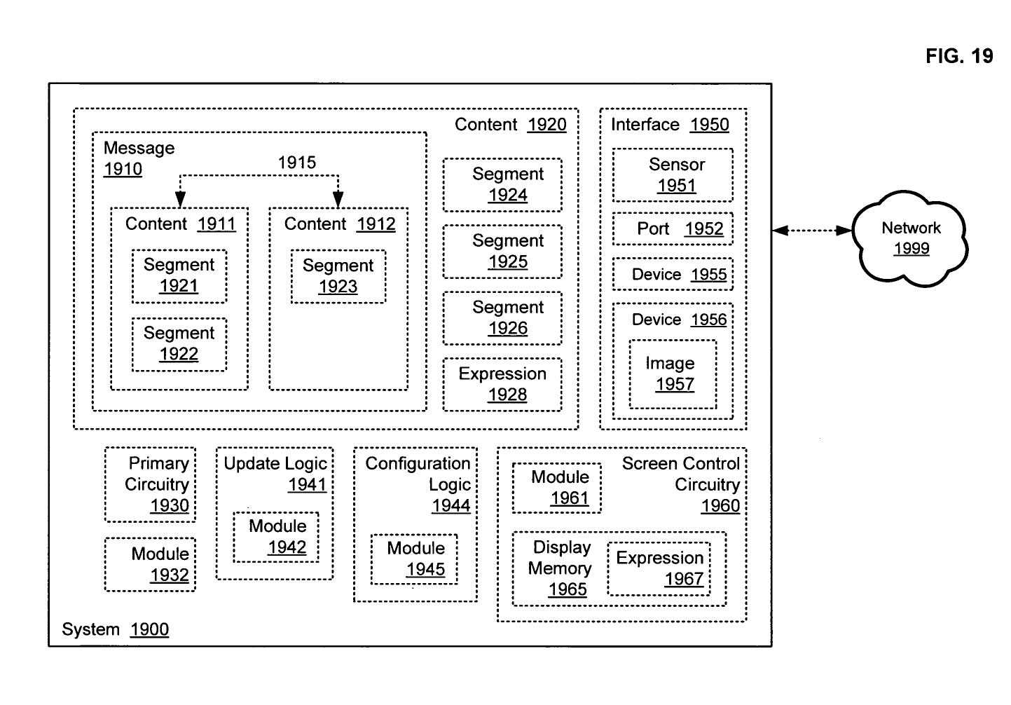

With reference now to FIG. 19, shown is another example of a system that may serve as a context for introducing one or more processes and/or devices described herein. System 1900 may be operable for interaction with network 1999, and may include one or more instances of content 1920, interfaces 1950, primary circuitry 1930, module 1932, one or more modules 1942 of update logic 1941, one or more modules 1945 of configuration logic 1944, or screen control circuitry 1960. Content 1920 may, for example, include one or more instances of messages 1910, segments 1924, 1925, 1926, or other expressions 1928. Message 1910 may comprise instances of content 1911, 1912 having a relationship 1915. As shown, for example, content 1911 may comprise segments 1921, 1922 and content 1912 may comprise 1923. Interface 1950 may comprise one or more instances of sensors 1951, ports 1952, or images 1957 or other data that may be indicated or otherwise handled by one or more interface devices 1955, 1956. Screen control circuitry 1960 may comprise one or more display memory 1965 operable for holding expression 1967 during presentation, or other modules 1961.

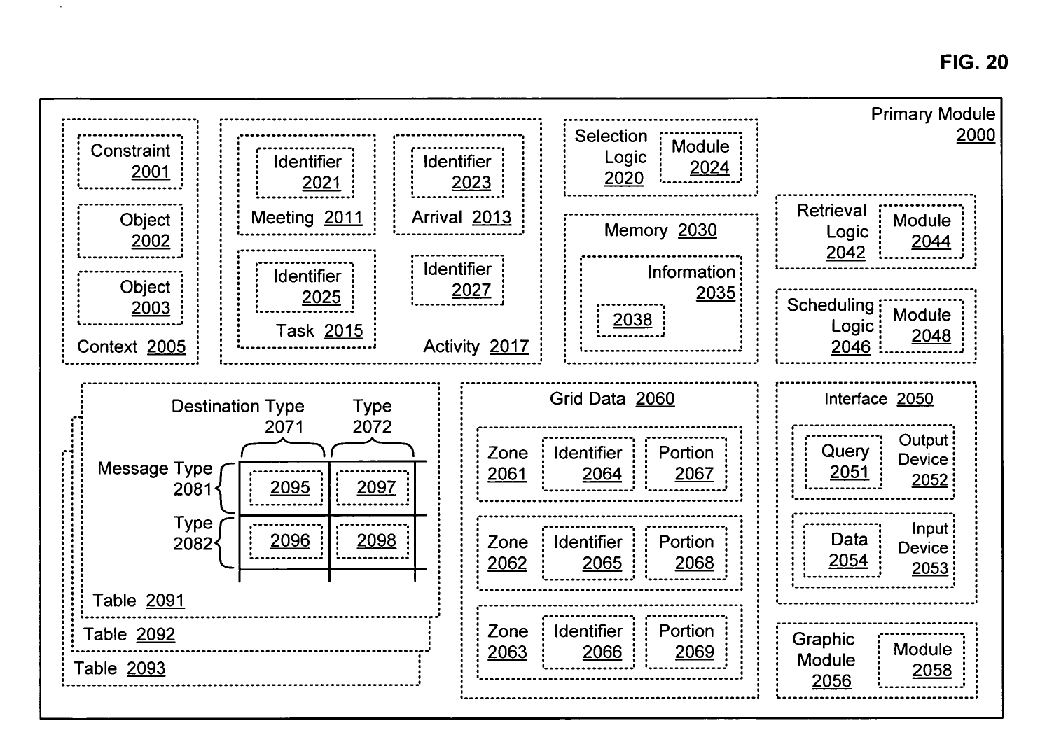

With reference now to FIG. 20, shown is another example of a system that may serve as a context for introducing one or more processes and/or devices described herein. Primary module 2000 may include one or more instances of constraints 2001 or other objects 2002, 2003 of respective contexts 2005 relating to one or more activities 2017. Primary module 2000 may further include one or more instances of modules 2024 of selection logic 2020, memories 2030, modules 2044 of retrieval logic 2042, modules 2048 of scheduling logic 2046, tables 2091, 2092, 2093 or similar grid data 2060, interfaces 2050, or other modules 2058 (of graphic modules 2056, for example). Memory 2030 may contain one or more instances of identifiers 2038 or other working data or other information 2035 for modules as described herein. Table 2091 may comprise one or more instances of segments 2095, 2096, 2097, 2098 each relating with one or more respective destination types 2071, 2072 and message types 2081, 2082 as shown. Grid data 2060 may comprise one or more instances of identifiers 2064, 2065, 2066 or other portions 2067, 2068, 2069 in each of respective zones 2061, 2062, 2063. Interface 2050 comprises one or more instances of output devices 2052 (operable for handling one or more queries 2051, for example) or input devices 2053 (operable for handling data 2054, for example).

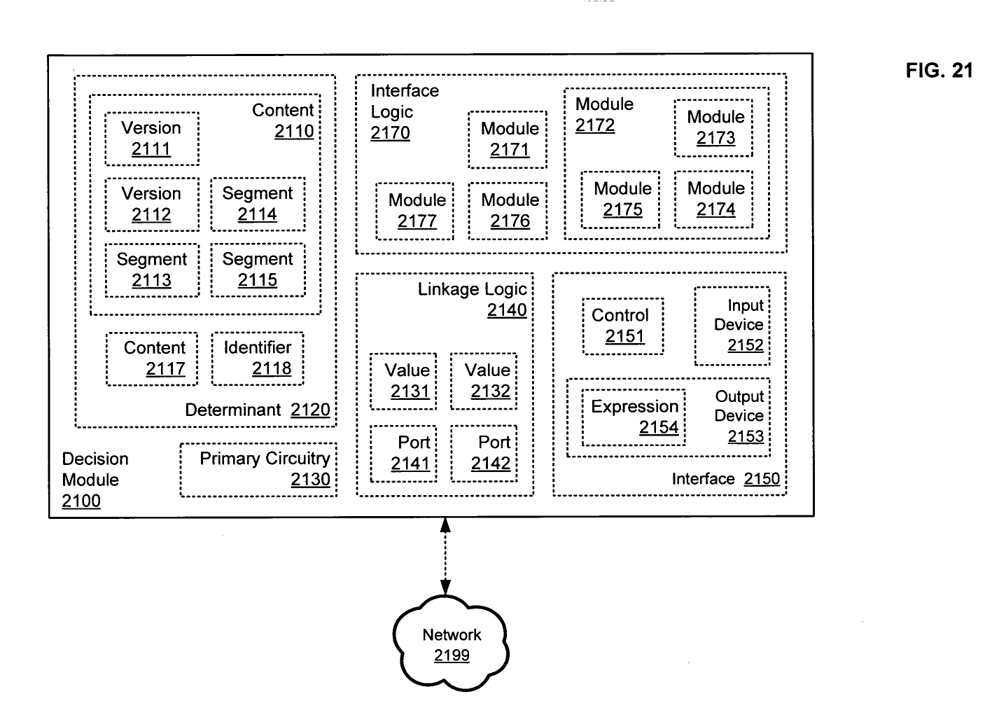

With reference now to FIG. 21, shown is another example of a system that may serve as a context for introducing one or more processes and/or devices described herein. Decision module 2100 may include one or more instances of content 2110, 2117, identifiers 2118, or other determinants 2120; primary circuitry 2130; linkage logic 2140; interface 2150; or interface logic 2170. Content 2110 may comprise one or more instances of versions 2111, 2112 and/or respective segments 2113, 2114, 2115. Linkage logic 2140 may incorporate or otherwise relate two or more values 2131, 2132, optionally via one or more ports 2141, 2142. Interface 2150 may comprise one or more instances of controls 2151, input devices 2152, or output devices 2153 operable for presenting expressions 2154 as described herein. Interface logic 2170 may likewise comprise one or more nested or other modules 2171, 2172, 2173, 2174, 2175, 2176, 2177 as described herein.

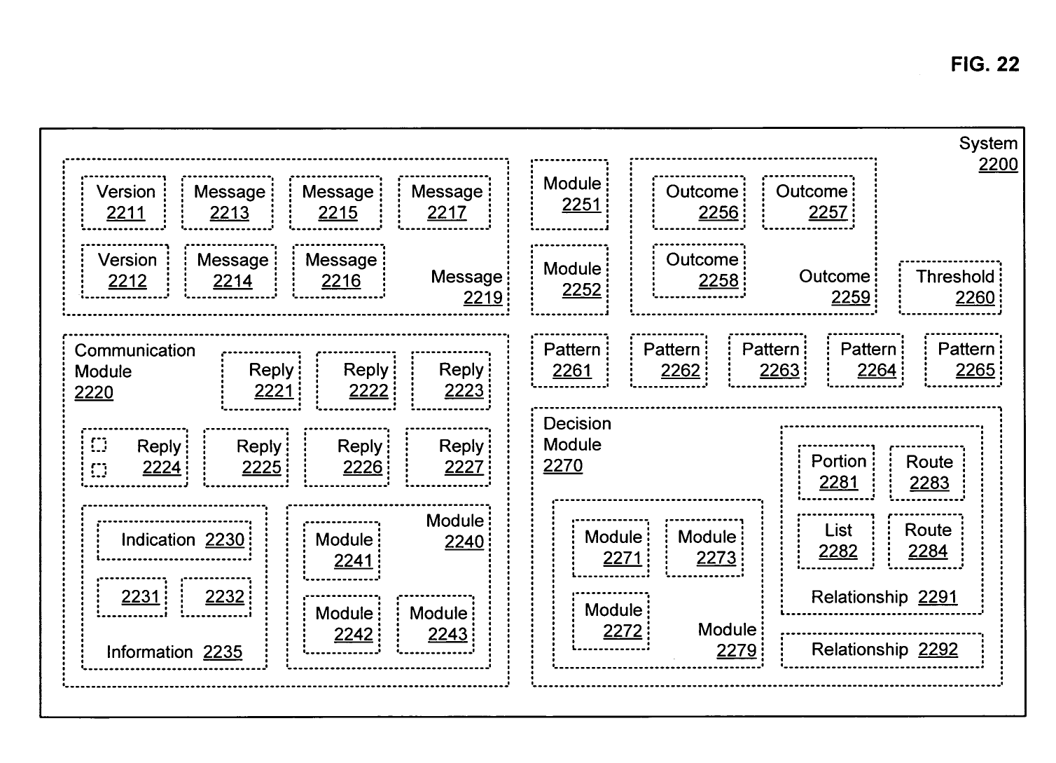

With reference now to FIG. 22, shown is another example of a system that may serve as a context for introducing one or more processes and/or devices described herein. System 2200 may comprise one or more instances of (respective versions 2211, 2212 or other) messages 2213, 2214, 2215, 2216, 2217, 2219. System 2200 may further comprise one or more instances of outcomes 2256, 2257, 2258, 2259; thresholds 2260; patterns 2261, 2262, 2263, 2264, 2265; or communication modules 2220, decision modules 2270, or other modules 2251, 2252. Communication module 2220 may comprise one or more replies 2221, 2222, 2223, 2224, 2225, 2226, 2227 or other information 2235, as well as one or more modules 2240, 2241, 2242, 2243. Information 2235 may, for example, comprise one or more instances of pattern instances 2231, 2232 or other indications 2230. Decision module 2270 may comprise one or more instances of nested or other modules 2271, 2272, 2273, 2279 or relationships 2291, 2292, which may include one or more distribution lists 2282, routes 2283, 2284, or other portions 2281 as described herein.

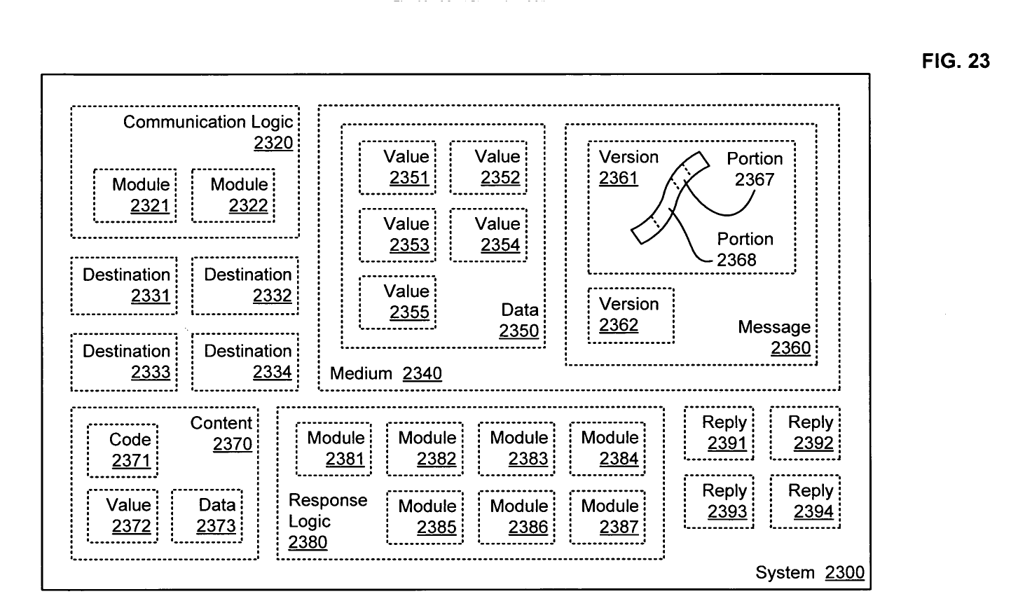

With reference now to FIG. 23, shown is another example of a system that may serve as a context for introducing one or more processes and/or devices described herein. System 2300 may include one or more instances of module 2321, 2322 of communication logic 2320; destinations 2331, 2332, 2333, 2334; media 2340; code 2371, values 2372, data 2373 or other content 2370; modules 2381, 2382, 2383, 2384, 2385, 2386, 2387 of response logic 2380; or replies 2391, 2392, 2393, 2394. Medium 2340, for example, may comprise one or more instances of values 2351, 2352, 2353, 2354, 2355 or other data 2350 as well as respective portions 2367, 2368 (e.g. of one or more versions 2361, 2362) of message 2360.

Some systems above illustrate elements provided without explicit operational illustrations, particularly with regard to FIGS. 4-23. For further information about such elements and related technology, the following patent applications filed on even date herewith are incorporated by reference to the extent not inconsistent herewith: [Attorney Docket # 0107-003-004-000000] (“Layering Destination-Dependent Content Handling Guidance”); [Attorney Docket # 0107-003-005-000000] (“Using Destination-Dependent Criteria to Guide Data Transmission Decisions; [Attorney Docket # 0107-003-007-000000] (“Message-Reply-Dependent Update Decisions”); and [Attorney Docket # 0107-003-008-000000] (“Layering Prospective Activity Information”).

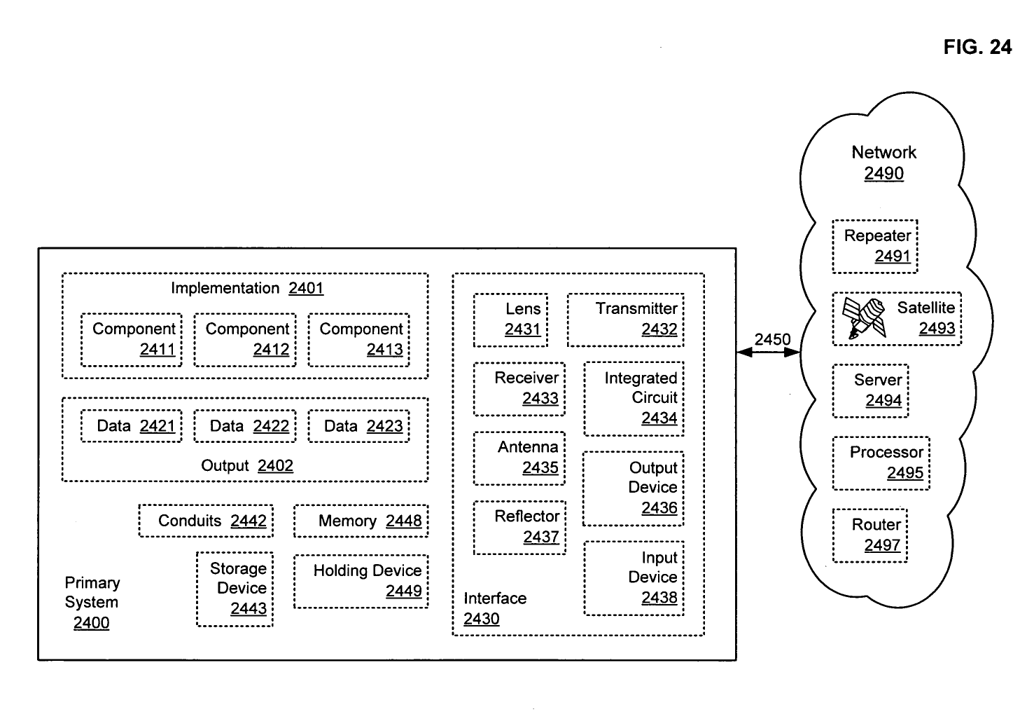

With reference now to FIG. 24, shown is an example of a system that may serve as a context for introducing one or more processes, systems or other articles described herein. Primary system 2400 may include one or more instances of implementations 2401 or outputs 2402 that may be held or transmitted by interfaces 2430, conduits 2442, storage devices 2443, memories 2448, or other holding devices 2449 or the like. In various embodiments as described herein, for example, one or more instances of implementation components 2411, 2412, 2413 or implementation output data 2421, 2422, 2423 may each be expressed in any aspect or combination of software, firmware, or hardware as signals, data, designs, logic, instructions, or the like. The interface(s) 2430 may include one or more instances of lenses 2431, transmitters 2432, receivers 2433, integrated circuits 2434, antennas 2435, output devices 2436, reflectors 2437, input devices 2438, or the like for handling data or communicating with local users or with network 2490 via linkage 2450, for example. Several variants of FIG. 24 are described below with reference to one or more instances of repeaters 2491, communication satellites 2493, servers 2494, processors 2495, routers 2497, or other elements of network 2490.

Those skilled in the art will recognize that some list items may also function as other list items. In the above-listed types of media, for example, some instances of interface(s) 2430 may include conduits 2442, or may also function as storage devices that are also holding devices 2449. One or more transmitters 2432 may likewise include input devices or bidirectional user interfaces, in many implementations of interface(s) 2430. Each such listed term should not be narrowed by any implication from other terms in the same list but should instead be understood in its broadest reasonable interpretation as understood by those skilled in the art.

Several variants described herein refer to device-detectable “implementations” such as one or more instances of computer-readable code, transistor or latch connectivity layouts or other geometric expressions of logical elements, firmware or software expressions of transfer functions implementing computational specifications, digital expressions of truth tables, or the like. Such instances can, in some implementations, include source code or other human-readable portions. Alternatively or additionally, functions of implementations described herein may constitute one or more device-detectable outputs such as decisions, manifestations, side effects, results, coding or other expressions, displayable images, data files, data associations, statistical correlations, streaming signals, intensity levels, frequencies or other measurable attributes, packets or other encoded expressions, or the like from invoking or monitoring the implementation as described herein.

Referring again to FIG. 2, flow 200 may be performed by one or more instances of server 2494 remote from primary system 2400, for example, but operable to cause output device(s) 2436 to receive and present results via linkage 2450. Alternatively or additionally, device-detectable data 2422 may be borne by one or more instances of signal-bearing conduits 2442, holding devices 2449, integrated circuits 2434, or the like as described herein. Such data may optionally be configured for transmission by a semiconductor chip or other embodiment of integrated circuit 2434 that contains or is otherwise operatively coupled with antenna 2435 (in a radio-frequency identification tag, for example).

In some variants, some instances of flow 200 may be implemented entirely within primary system 2400, optionally configured as a stand-alone system. Operation 250 may be implemented by configuring component 2411 as logic for obtaining an indication of whether one or more parties in a region can be classified using auditory or optical data, for example. This may be accomplished by including special-purpose instruction sequences or special-purpose-circuit designs for this function, for example, in optical or other known circuit fabrication operations, in programming by various known voltage modulation techniques, or otherwise as described herein or known by those skilled in the art. Output data 2421 from such a component in primary system 2400 or network 2490 may be recorded by writing to or otherwise configuring available portions of storage device(s) 2443.

Alternatively or additionally, such specific output data may be transmitted by configuring transistors, relays, or other drivers or conduits 2442 of primary system 2400 to transfer it to component 2412, for example. Component 2412 may perform operation 280 via implementation as logic for signaling a decision of which version of a message to introduce into the region at least partly based on the indication of whether the one or more parties can be classified using the auditory or optical data, for example. Implementation output data 2422 from such a component in primary system 2400 or network 2490 may be recorded into available portions of storage device(s) 2443 or sent to component 2413, for example. Output 2402 from flow 200 may likewise include other data 2423 as described herein. Each portion of implementation 2401 may likewise include one or more instances of software, hardware, or the like implementing logic that may be expressed in several respective forms as described herein or otherwise understood by those skilled in the art.

In some embodiments, output device 2436 may indicate an occurrence of flow 200 concisely as a decision, an evaluation, an effect, a hypothesis, a probability, a notification, or some other useful technical result. For example, such “indicating” may comprise such modes as showing, signifying, acknowledging, updating, explaining, associating, or the like in relation to any past or ongoing performance of such actions upon the common item(s) as recited. Such indicating may also provide one or more specifics about the occurrence: the parties or device(s) involved, a description of the method or performance modes used, any sequencing or other temporal aspects involved, indications of resources used, location(s) of the occurrence, implementation version indications or other update-indicative information, or any other such contextual information that may be worthwhile to provide at potential output destinations.

Concise indication may occur, for example, in a context in which at least some items of data 2421-2423 do not matter, or in which a recipient may understand or access portions of data 2421-2423 without receiving a preemptive explanation of how it was obtained. By distilling at least some output 2402 at an “upstream” stage (which may comprise integrated circuit 2434, for example, in some arrangements), downstream-stage media (such as other elements of network 2490, for example) may indicate occurrences of various methods described herein more effectively. Variants of flow 200, for example, may be enhanced by distillations described herein, especially in bandwidth-limited transmissions, security-encoded messages, long-distance transmissions, complex images, or compositions of matter bearing other such expressions.

In some variants, a local implementation comprises a service operable for accessing a remote system running a remote implementation. In some embodiments, such “accessing” may include one or more instances of establishing or permitting an interaction between the server and a local embodiment such that the local embodiment causes or uses another implementation or output of one or more herein-described functions at the server. Functioning as a web browser, remote terminal session, or other remote activation or control device, for example, interface(s) 2430 may interact with one or more primary system users via input and output devices 2436, 2438 so as to manifest an implementation in primary system 2400 via an interaction with server 2494, for example, running a secondary implementation of flow 200. Such local implementations may comprise a visual display supporting a local internet service to the remote server, for example. Such a remote server may control or otherwise enable one or more instances of hardware or software operating the secondary implementation outside a system, network, or physical proximity of primary system 2400. For a building implementing primary system 2400, for example, “remote” devices may include those in other countries, in orbit, or in adjacent buildings. In some embodiments, “running an implementation” may include invoking one or more instances of software, hardware, firmware, or the like atypically constituted or adapted to facilitate methods or functions as described herein. For example, primary system 2400 running an implementation of flow 200 may be a remote activation of a special-purpose computer program resident on server 2494 via an internet browser session interaction through linkage 2450, mediated by input device 2438 and output device 2436.

In some variants, some or all of components 2411-2413 may be borne in various data-handling elements—e.g., in one or more instances of storage devices 2443, in memories 2448 or volatile media, passing through linkage 2450 with network 2490 or other conduits 2442, in one or more registers or data-holding devices 2449, or the like. For example, such processing or configuration can occur in response to user data or the like received at input device 2438 or may be presented at output device 2436. Instances of input devices 2438 may (optionally) include one or more instances of cameras or other optical devices, hand-held systems or other portable systems, keypads, sensors, or the like as described herein. Output device(s) 2436 may likewise include one or more instances of image projection modules, touch screens, wrist-wearable systems or the like adapted to be worn while in use, headphones and speakers, eyewear, liquid crystal displays (LCDs), actuators, lasers, organic or other light-emitting diodes, phosphorescent elements, portions of (hybrid) input devices 2438, or the like.

A device-detectable implementation of variants described herein with reference to flow 200 for example, may be divided into several components 2411-2413 carried by one or more instances of active modules such as signal repeaters 2491, communication satellites 2493, servers 2494, processors 2495, routers 2497, or the like. For example, in some embodiments, component 2412 may be borne by an “upstream” module (e.g., repeater 2491 or the like) while or after component 2411 is borne in a “downstream” module (e.g., another instance of repeater 2491, communication satellite 2493, server 2494, or the like). Such downstream modules may “accept” such bits or other portions of implementation 2401 sequentially, for example, such as by amplifying, relaying, storing, checking, or otherwise processing what was received actively. Sensors and other “upstream” modules may likewise “accept” raw data, such as by measuring physical phenomena or accessing one or more databases.

In some embodiments, a medium bearing data (or other such event) may be “caused” (directly or indirectly) by one or more instances of prior or contemporaneous measurements, decisions, transitions, circumstances, or other causal determinants. Any such event may likewise depend upon one or more other prior, contemporaneous, or potential determinants, in various implementations as taught herein. In other words, such events can occur “in response” to both preparatory (earlier) events and triggering (contemporaneous) events in some contexts. Output 2402 may result from more than one component of implementations 2401 or more than one operation of flow 200, for example.

In some embodiments, such integrated circuits 2434 may comprise transistors, capacitors, amplifiers, latches, converters, or the like on a common substrate of a semiconductor material, operable to perform computational tasks or other transformations. An integrated circuit may be application-specific (“ASIC”) in that it is designed for a particular use rather than for general purpose use. An integrated circuit may likewise include one or more instances of memory circuits, processors, field-programmable gate arrays (FPGA's), antennas, or other components, and may be referred to as a system-on-a-chip (“SoC”).

In some embodiments, one or more instances of integrated circuits or other processors may be configured to perform auditory pattern recognition. In FIG. 24, for example, instances of the one or more input devices 2438 may include a microphone or the like operable to provide auditory samples in data 2421-2423. Some form or portion of such output may be provided remotely, for example, to one or more instances of neural networks or other configurations of remote processors 2495 operable to perform automatic or supervised speech recognition, selective auditory data retention or transmission, or other auditory pattern recognition, upon the samples. Alternatively or additionally such sound-related data may include annotative information relating thereto such as a capture time or other temporal indications, capture location or other source information, language or other content indications, decibels or other measured quantities, pointers to related data items or other associative indications, or other data aggregations or distillations as described herein.

In some embodiments, one or more instances of integrated circuits or other processors may be configured for optical image pattern recognition. In FIG. 24, for example, instances of lenses 2431 or other input devices 2438 may include optical sensors or the like operable to provide one or more of geometric, hue, or optical intensity information in data 2421-2423. Some form or portion of such output may be provided locally, for example, to one or more instances of optical character recognition software, pattern recognition processing resources, or other configurations of integrated circuits 2434 operable to perform automatic or supervised image recognition, selective optical data retention or transmission, or the like. Alternatively or additionally such image-related data may include annotative information relating thereto such as a capture time or other temporal indications, capture location or other source information, language or other content indications, pointers to related data items or other associative indications, or other data aggregations or distillations as described herein.

In some embodiments, one or more instances of integrated circuits or other processors may be configured to perform linguistic pattern recognition. In FIG. 24, for example, instances of input devices 2438 may include keys, pointing devices, microphones, sensors, reference data, or the like operable to provide spoken, written, or other symbolic expressions in data 2421-2423. Some form or portion of such output may be provided locally, for example, to one or more instances of translation utilities, compilers, or other configurations of integrated circuits 2434 operable to perform automatic or supervised programming or other language recognition, selective linguistic data retention or transmission, or the like. Alternatively or additionally such language-related data may include annotative information relating thereto such as a capture time or other temporal indications, capture location or other source information, language or other content indications, pointers to related data items or other associative indications, or other data classifications, aggregations, or distillations as described herein.

In some embodiments, one or more antennas 2435 or receivers 2433 may include a device that is the receiving end of a communication channel as described herein. For example, such a receiver may gather a signal from a dedicated conduit or from the environment for subsequent processing and/or retransmission. As a further example, such antennas or other receivers may include one or more instances of wireless antennas, radio antennas, satellite antennas, broadband receivers, digital subscriber line (DSL) receivers, modem receivers, transceivers, or configurations of two or more such devices for data reception as described herein or otherwise known.

In one variant, two or more respective portions of output data 2421-2423 may be sent from server 2494 through respective channels at various times, one portion passing through repeater 2491 and another through router 2497. Such channels may each bear a respective portion of a data aggregation or extraction, a publication, a comparative analysis or decision, a record selection, digital subscriber content, statistics or other research information, a resource status or potential allocation, an evaluation, an opportunity indication, a test or computational result, or some other output 2402 of possible interest. Such distributed media may be implemented as an expedient or efficient mode of bearing such portions of output data to a common destination such as interface 2430 or holding device 2449. Alternatively or additionally, some such data may be transported by moving a medium (carried on storage device 2443, for example) so that only a small portion (a purchase or other access authorization, for example, or a contingent or supplemental module) is transferred via linkage 2450.

In some embodiments, one or more instances of signal repeaters 2491 may include a device or functional implementation that receives a signal and transmits some or all of the signal with one or more of an altered strength or frequency, or with other modulation (e.g., an optical-electrical-optical amplification device, a radio signal amplifier or format converter, a wireless signal amplifier, or the like). A repeater may convert analog to digital signals or digital to analog signals, for example, or perform no conversion. Alternatively or additionally, a repeater may reshape, retime or otherwise reorder an output for transmission. A repeater may likewise introduce a frequency offset to an output signal such that the received and transmitted frequencies are different. A repeater also may include one or more instances of a relay, a translator, a transponder, a transceiver, an active hub, a booster, a noise-attenuating filter, or the like.

In some embodiments, such communication satellite(s) 2493 may be configured to facilitate telecommunications while in a geosynchronous orbit, a Molniya orbit, a low earth orbit, or the like. Alternatively or additionally, a communication satellite may receive or transmit, for example, telephony signals, television signals, radio signals, broadband telecommunications signals, or the like.

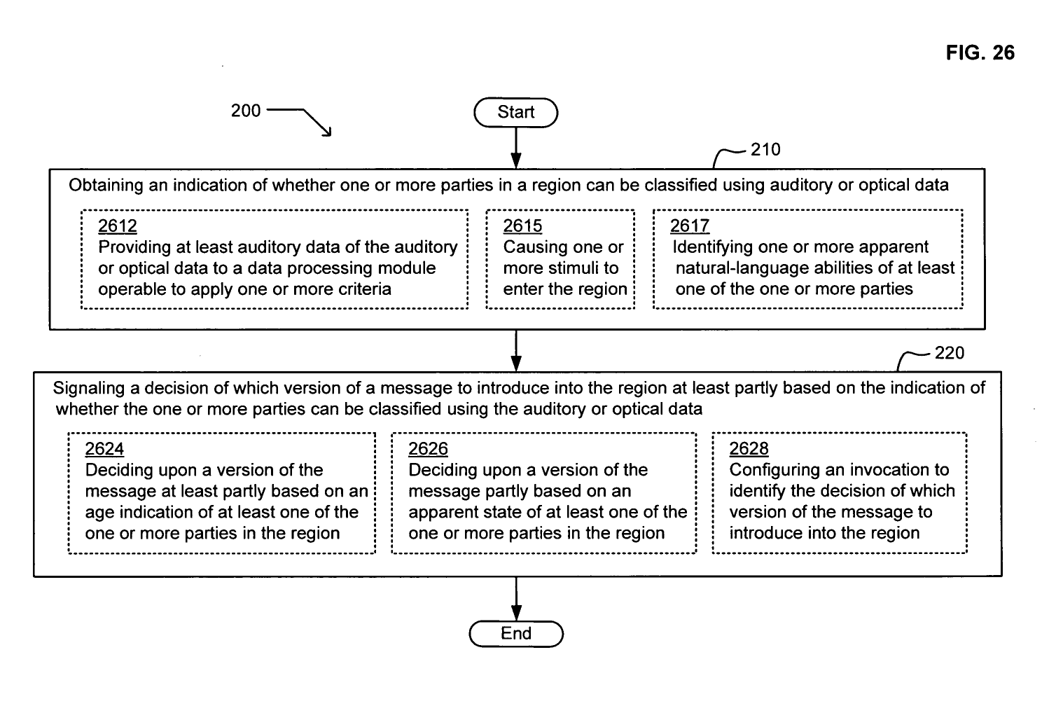

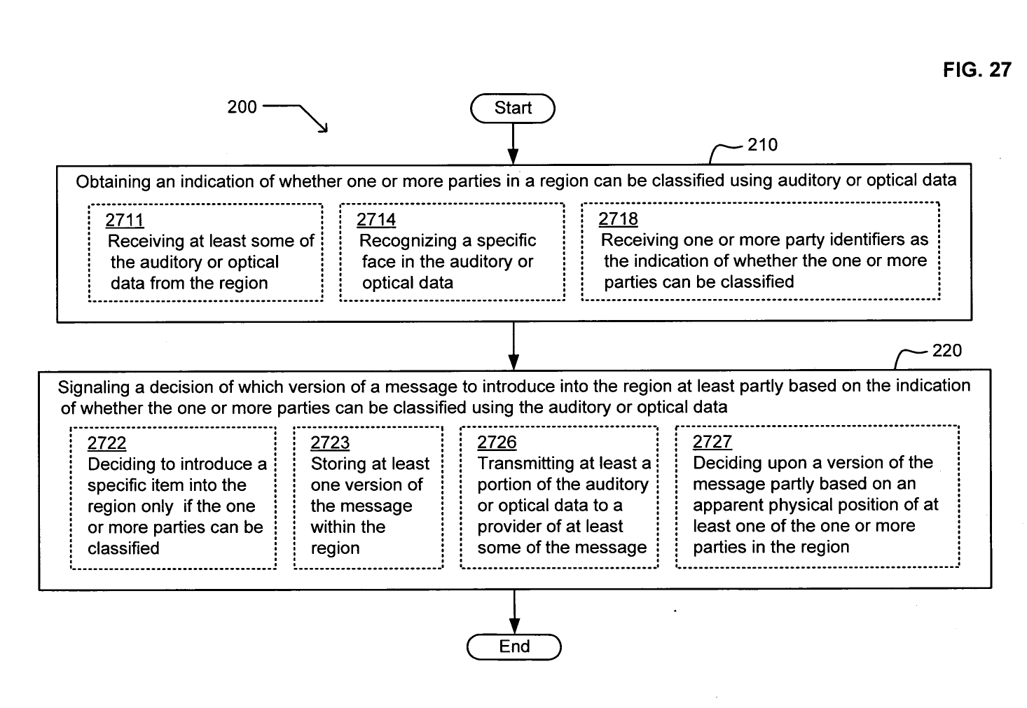

In some variants, processor 2495 or any components 2411-2413 of implementation 2401 may (optionally) be configured to perform flow variants as described herein with reference to FIGS. 26-27. An occurrence of such a variant may be expressed as a computation, a transition, or as one or more other items of data 2421-2423 described herein. Such output 2402 may be generated, for example, by depicted components of primary system 2400 or network 2490 including one or more features as described herein.

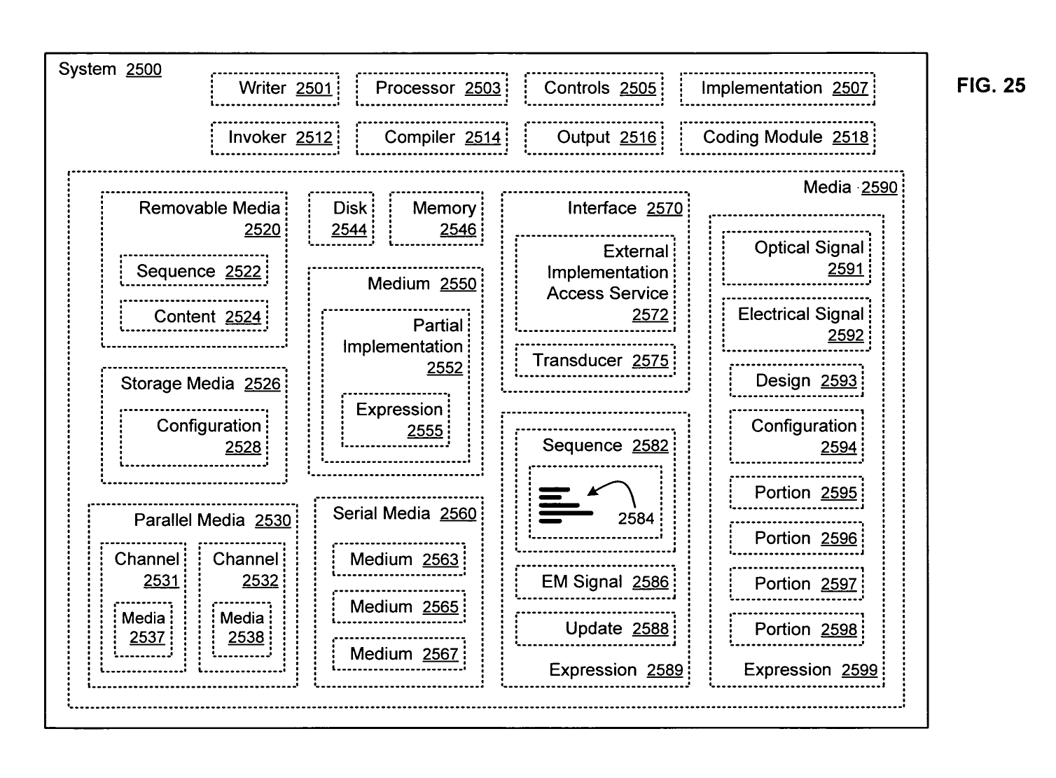

With reference now to FIG. 25, shown is an example of another system that may serve as a context for introducing one or more processes, systems or other articles described herein. As shown system 2500 comprises one or more instances of writers 2501, processors 2503, controls 2505, software or other implementations 2507, invokers 2512, compilers 2514, outputs 2516, coding modules 2518, or the like with one or more media 2590 bearing expressions or outputs thereof. In some embodiments, such media may include distributed media bearing a divided or otherwise distributed implementation or output. For example, in some embodiments, such media may include two or more physically distinct solid-state memories, two or more transmission media, a combination of such transmission media with one or more data-holding media configured as a data source or destination, or the like.

In some embodiments, transmission media may be “configured” to bear an output or implementation (a) by causing a channel in a medium to convey a portion thereof or (b) by constituting, adapting, addressing, or otherwise linking to such media in some other mode that depends upon one or more atypical traits of the partial or whole output or implementation. Data-holding elements of media may likewise be “configured” to bear an output or implementation portion (a) by holding the portion in a storage or memory location or (b) by constituting, adapting, addressing, or otherwise linking to such media in some other mode that depends upon one or more atypical traits of the partial or whole output or implementation. Such atypical traits may include a name, address, portion identifier, functional description, or the like sufficient to distinguish the output, implementation, or portion from a generic object.

In some embodiments described herein, “logic” and similar implementations may include software or other control structures operable to guide device operation. Electronic circuitry, for example, may manifest one or more paths of electrical current constructed and arranged to implement various logic functions as described herein. In some embodiments, one or more media are “configured to bear” a device-detectable implementation if such media hold or transmit a special-purpose device instruction set operable to perform a novel method as described herein. Alternatively or additionally, in some variants, an implementation may include special-purpose hardware or firmware components or general-purpose components executing or otherwise invoking special-purpose components. Specifications or other implementations may be transmitted by one or more instances of transmission media as described herein, optionally by packet transmission or otherwise by passing through distributed media at various times.

In some embodiments, one or more of the coding modules 2518 may be configured with circuitry for applying, imposing, or otherwise using a syntactic or other encoding constraint in forming, extracting, or otherwise handling respective portions of the device-detectable implementation or output. In encoding a software module or other message content, for example, compiler 2514 or coding module 2518 may implement one or more such constraints pursuant to public key or other encryption, applying error correction modes, certifying or otherwise annotating the message content, or implementing other security practices described herein or known by those skilled in the art. Alternatively or additionally, another instance of coding module 2518 may be configured to receive data (via receiver 2433, e.g.) and decode or otherwise distill the received data using one or more such encoding constraints. Compiler 2514 may, in some variants, convert one or more of components 2411-2413 from a corresponding source code form before the component(s) are transmitted across linkage 2450.

System 2500 may be implemented, for example, as one or more instances of stand-alone workstations, servers, vehicles, portable devices, removable media 2520, as components of primary system 2400 or network 2490 (of FIG. 24), or the like. Alternatively or additionally, media 2590 may include one or more instances of signal repeaters 2491, communication satellites 2493, servers 2494, processors 2495, routers 2497, portions of primary system 2400 as shown, or the like.

Media 2590 may include one or more instances of removable media 2520, tapes or other storage media 2526; parallel (transmission) media 2530; disks 2544; memories 2546; other data-handling media 2550; serial media 2560; interfaces 2570; or expressions 2589, 2599. Removable media 2520 may bear one or more device-detectable instances of instruction sequences 2522 or other implementations of flow 200, for example. Alternatively or additionally, in some embodiments, removable media 2520 may bear alphanumeric data, audio data, image data, structure-descriptive values, or other content 2524 in a context that indicates an occurrence of one or more flows 200. In some circumstances, transmission media may bear respective portions of implementations as described herein serially or otherwise non-simultaneously. In some variants in which two portions 2597, 2598 constitute a partial or complete software implementation or product of a novel method described herein, portion 2597 may follow portion 2598 successively through serial media 2563, 2565, 2567 (with transmission of portion 2597 partly overlapping in time with transmission of portion 2598 passing through medium 2563, for example). As shown, parallel channels 2531, 2532 are respectively implemented at least in media 2537, 2538 of a bus or otherwise effectively in isolation from one another. In some embodiments, a bus may be a system of two or more signal paths—not unified by a nominally ideal conduction path between them—configured to transfer data between or among internal or external computer components. For example, one data channel may include a power line (e.g., as medium 2565) operable for transmitting content of the device-detectable implementation as described herein between two taps or other terminals (e.g., as media 2563, 2567 comprising a source and destination). In another such configuration, one or more media 2537 of channel 2531 may bear portion 2597 before, while or after one or more other media 2538 of parallel channel 2532 bear portion 2598. In some embodiments, such a process can occur “while” another process occurs if they coincide or otherwise overlap in time substantially (by several clock cycles, for example). In some embodiments, such a process can occur “after” an event if any instance of the process begins after any instance of the event concludes, irrespective of other instances overlapping or the like.

In a variant in which a channel through medium 2550 bears an expression 2555 partially implementing an operational flow described herein, the remainder of the implementation may be borne (earlier or later, in some instances) by the same medium 2550 or by one or more other portions of media 2590 as shown. In some embodiments, moreover, one or more controls 2505 may configure at least some media 2590 by triggering transmissions as described above or transmissions of one or more outputs 2516 thereof.

In some embodiments, the one or more “physical media” may include one or more instances of conduits, layers, networks, static storage compositions, or other homogenous or polymorphic structures or compositions suitable for bearing signals. In some embodiments, such a “communication channel” in physical media may include a signal path between two transceivers or the like. A “remainder” of the media may include other signal paths intersecting the communication channel or other media as described herein. In some variants, another exemplary system comprises one or more physical media 2590 constructed and arranged to receive a special-purpose sequence 2582 of two or more device-detectable instructions 2584 for implementing a flow as described herein or to receive an output of executing such instructions. Physical media 2590 may (optionally) be configured by writer 2501, transmitter 2432, or the like.

In some embodiments, such a “special-purpose” instruction sequence may include any ordered set of two or more instructions directly or indirectly operable for causing multi-purpose hardware or software to perform one or more methods or functions described herein: source code, macro code, controller or other machine code, or the like. In some embodiments, an implementation may include one or more instances of special-purpose sequences 2582 of instructions 2584, patches or other implementation updates 2588, configurations 2594, special-purpose circuit designs 2593, or the like. Such “designs,” for example, may include one or more instances of a mask set definition, a connectivity layout of one or more gates or other logic elements, an application-specific integrated circuit (ASIC), a multivariate transfer function, or the like.

Segments of such implementations or their outputs may (optionally) be manifested one or more information-bearing static attributes comprising the device-detectable implementation. Such attributes may, in some embodiments, comprise a concentration or other layout attribute of magnetic or charge-bearing elements, visible or other optical elements, or other particles in or on a liquid crystal display or other solid-containing medium. Solid state data storage modules or other such static media may further comprise one or more instances of laser markings, barcodes, human-readable identifiers, or the like, such as to indicate one or more attributes of the device-detectable implementation. Alternatively or additionally such solid state or other solid-containing media may include one or more instances of semiconductor devices or other circuitry, magnetic or optical digital storage disks, dynamic or flash random access memories (RAMs), or the like. Magnetoresistive RAMs may bear larger implementation or output portions or aggregations safely and efficiently, moreover, and without any need for motors or the like for positioning the storage medium.

Segments of such implementations or their outputs may likewise be manifested in electromagnetic signals 2586, laser or other optical signals 2591, electrical signals 2592, or the like. In some embodiments, for example, such electrical or electromagnetic signals may include one or more instances of static or variable voltage levels or other analog values, radio frequency transmissions or the like. In some embodiments, the above-mentioned “optical” signals may likewise include one or more instances of time- or position-dependent, device-detectable variations in hue, intensity, or the like. Alternatively or additionally, portions of such implementations or their outputs may manifest as one or more instances of magnetic, magneto-optic, electrostatic, or other physical configurations 2528 of nonvolatile storage media 2526 or as external implementation access services 2572.

In some embodiments, physical media may be configured by being “operated to bear” or “operated upon to bear” a signal. For example, they may include physical media that generate, transmit, conduct, receive, or otherwise convey or store a device-detectable implementation or output as described herein. Such conveyance or storing of a device-detectable implementation or output may be carried out in a distributed fashion at various times or locations, or such conveyance or storing of a device-detectable implementation or output may be done at one location or time. As discussed above, such physical media “operated to bear” or “operated upon to bear” may include physical media that are atypically constituted or adapted to facilitate methods or functions as described herein.

In some configurations, one or more output devices 2436 may present one or more results of signaling a decision of which version of a message to introduce into the region at least partly based on the indication of whether the one or more parties can be classified using the auditory or optical data in response to interface(s) 2430 receiving one or more invocations or outputs of an implementation of this function via linkage 2450. Such an “invocation” may, in some embodiments, comprise one or more instances of requests, hardware or software activations, user actions, or other determinants as described herein. Alternatively or additionally, in some embodiments, one or more input devices 2438 may later receive one or more invocations. In contexts like these, processor 2495 or other components of network 2490 may likewise constitute a secondary implementation having access to a primary instance of interface 2430 implementing methods like flow 200 as described herein.

Serial media 2560 comprises a communication channel of two or more media configured to bear a transition or other output increment successively. In some embodiments, for example, serial media 2560 may include a communication line or wireless medium (e.g., as medium 2565) between two signal-bearing conduits (e.g., terminals or antennas as media 2563, 2567). Alternatively or additionally, one or more lenses 2431 or other light-transmissive media may comprise a serial medium between a light-transmissive medium and a sensor or other light receiver 2433 or transmitter 2432. In some embodiments, such “light-transmissive” media may (optionally) comprise metamaterials or other media operable for bearing one or more instances of microwave signals, radiowave signals, visible light signals, or the like.

In some embodiments, such a lens may be an optical element that causes light to converge or diverge along one or more signal paths. Such a light-transmissive medium may include a signal-bearing conduit, glass, or other physical medium through which an optical signal may travel. More generally, a signal-bearing conduit may be an electrical wire, a telecommunications cable, a fiber-optic cable, or a mechanical coupling or other path for the conveyance of analog or digital signals.

Alternatively or additionally, system 2500 may likewise include one or more instances of media for handling implementations or their outputs: satellite dishes or other reflectors 2437, antennas 2435 or other transducers 2575, arrays of two or more such devices configured to detect or redirect one or more incoming signals, caching elements or other data-holding elements (e.g., disks 2544, memories 2546, or other media 2590), integrated circuits 2434, or the like. In some variants, one or more media may be “configured” to bear a device-detectable implementation as described herein by being constituted or otherwise specially adapted for that type of implementation at one or more respective times, overlapping or otherwise. Such “signal-bearing” media may include those configured to bear one or more such signals at various times as well as those currently bearing them.

In some embodiments, such caching elements may comprise a circuit or device configured to store data that duplicates original values stored elsewhere or computed earlier in time. For example, a caching element may be a temporary storage area where frequently-accessed data may be held for rapid access by a computing system. A caching element likewise may be machine-readable memory (including computer-readable media such as random access memory or data disks). In some embodiments, such caching elements may likewise comprise a latching circuit or device configured to store data that has been modified from original values associated with the data (held elsewhere or computed earlier in time, for example).

In one variant, respective portions 2595, 2596 of an expression 2599 of implementation 2507 may be sent through respective channels at various times. Invoker 2512 may request or otherwise attempt to activate a computer program or streaming media overseas via a telephone cable or other channel 2531. Meanwhile, output 2516 may attempt to trigger a session or other partial implementation 2552, success in which may be indicated by receiving expression 2555 into a visual display or other medium 2550. Such a program or other implementation may be made complete, for example, once both of these attempts succeed.

In some embodiments, transducer(s) 2575 may comprise one or more devices that convert a signal from one form to another form. For example, a transducer may be a cathode ray tube that transforms electrical signals into visual signals. Another example of a transducer comprises a microelectromechanical systems (“MEMS”) device, which may be configured to convert mechanical signals into electrical signals (or vice versa).

With reference now to FIG. 26, there are shown several variants of the flow 200 of FIG. 2. Operation 210—obtaining an indication of whether one or more parties in a region can be classified using auditory or optical data—may include one or more of the following operations: 2612, 2615, or 2617. In some embodiments, various preparatory or other optional aspects or variants of operation 210 may be performed by one or more instances of modules 1630 for detection or the like as described herein. Operation 220—signaling a decision of which version of a message to introduce into the region at least partly based on the indication of whether the one or more parties can be classified using the auditory or optical data—may include one or more of the following operations: 2624, 2626, or 2628. In some embodiments, various preparatory or other optional aspects or variants of operation 220 may be performed by one or more instances of interaction modules 325, 1650 or other determinants or components as described herein implemented in one or more systems 330, 340, 350.

Operation 2612 describes providing at least auditory data of the auditory or optical data to a data processing module operable to apply one or more criteria (e.g. module 1634 transmitting or otherwise providing at least auditory data 139 to one or more data processing modules 1640, 1649 for applying respective filters 1641, 1647 each comprising one or more criteria 1643-1645). This can occur, for example, in a context in which system 1600 is implemented in system 130 or region 190 and in which detection module 1630 is configured to perform operation 210. Alternatively or additionally, one or more modules 1633, 1634 may be configured to perform operation 2612 upon composite sensor data 140 that includes at least some auditory data. In some variants, for example, such criteria 1644, 1645 may assist in classifying one or more parties according to their voices, footsteps, heartbeats, the timing with which they perform routine tasks such as typing their names, or other characteristic phenomena as described herein.

Operation 2615 describes causing one or more stimuli to enter the region (e.g. detection module 1630 causing one or more output devices 410 to present one or more questions or other stimuli 1611, 1612 in environment 405). This can occur, for example, in a context in which workstation 400 accesses or otherwise implements system 1600 and in which module 1632 prompts user 401 for a password, biometric input, or other behavior to assist in classifying user 401 or others in environment 405. Alternatively or additionally, the one or more stimuli 1612 may include a source of illumination or other mode of assisting with classification irrespective of such parties' cooperation. In some variants, for example, a flash may be used to enhance one or more photographs of ocular data or other subjects in environment 405. Alternatively or additionally, detection module 1630 may invoke one or more recognition modules 1628, 1629 for recognizing one or more special circumstances that may facilitate evaluation. Module 1629 may be configured for recognizing that the auditory or optical data indicates the region apparently containing exactly one person, for example, by recognizing a heartbeat or other biometric data, historical events such as people entering and leaving a region, or other sensory data. Even if tentative, such a recognition may warrant the use of queries or other specific stimuli at operation 2615 in some circumstances as described herein for determining whether the region is secure enough for some message versions. Alternatively or additionally, some circumstances are suitable for detection module 1630 simply to accept the decision of operation 220 from a party directly, for example, when the party is apparently alone.

Operation 2617 describes identifying one or more apparent natural-language abilities of at least one of the one or more parties (e.g. detection module 1630 invoking module 1637 for recognizing one or more instances 137 of complex phrases or other patterns 160 and recording one or more ability indications 1644 derived therefrom). This can occur, for example, in a context in which one or more parties in a region use slang, dated terms, natural language phrases indicative of fluency, terms of art indicative of knowledge, accents or other linguistic patterns indicative of who they are. Alternatively or additionally, one or more inferences 1647, 1634 about a party's identity may be derived by using one or more such patterns (as a weak inference) in combination with one or more other observations (for a stronger inference). In some variants, for example, module 1643 may estimate a likelihood of L % that user 303 is Mr. Wu partly based on a variety of linguistic factors: his use of proper English, his use of technical jargon, his accent, or the like. In some circumstances, module 1643 may achieve a higher likelihood by taking into account a variety of non-linguistic factors relating to known attributes of a subject individual: the individual's height, hair color, mode of dress, or the like. Those skilled in the art will be able to implement and/or enhance a variety of such estimates in light of these teachings. Such inferences may have a low enough certainty, in many cases, to warrant using a less-explicit version of a message. In some variants, for example, such a less-explicit version may include a portion that will only be revealed in response to a password, an explicit request, or some other mode of enhancing a confidence in putative identities of one or more parties in a region.

Operation 2624 describes deciding upon a version of the message at least partly based on an age indication of at least one of the one or more parties in the region (e.g. module 322 selecting version 332 in response to a determination by evaluation module 1661 that region 300 apparently contains one or more parties 303 who cannot be confirmed to be adults). This can occur, for example, in a context in which evaluation module 1661 has received at least some sensor data 1673 indicating that party 303 has not spoken or has a child's voice, that party 303 has a child's face or body proportions, that user 301 has indicated that one or more children are or are not present, or other such situations. Alternatively or additionally, evaluation module 1661 may provide or otherwise designate some other version 1672 in response to (a) an indication 1651 that someone in region 300 may apparently be older than a threshold age or (b) an indication 1652 that version 1672 may be more suitable for someone in region 300 as evaluated by two or more criteria of which at least one is based on a threshold related to age. In some variants, for example, version 1672 may only be deemed suitable for authorized individuals or other people apparently under a threshold height (such as one meter). In others, version 1672 may only be deemed preferable for an audience of identified individuals or others whose faces match their driver's license). In various embodiments, such indications 1651, 1652 may be provided in raw form (in sensor data 1673, for example), provided by a user (not shown) of evaluation module 1661, or generated automatically such as by pattern recognition.

Operation 2626 describes deciding upon a version of the message partly based on an apparent state of at least one of the one or more parties in the region (e.g. interaction module 1650 invoking decision module 347 for designating one or more versions 972-973 as suitable for presentation at output 320 partly based on party 303 apparently being asleep, distracted, locked out, or otherwise temporarily unable to monitor output device 320). This can occur, for example, in a context in which one or more systems 340, 350, 360 accessible to module 347 implement system 900 or other messages of multiple versions as described herein. Alternatively or additionally, gender or other less-transient attributes of one or more parties 303 may likewise influence which or how one or more versions 971 are presented. In some variants, for example, one or more components 982 of a selected version may be included or omitted in response to one or more indications that one or more parties 303 is listening to headphones or otherwise has a hearing impairment.

Operation 2628 describes configuring an invocation to identify the decision of which version of the message to introduce into the region (e.g. interaction module 1650 invoking module 1663 for generating one or more commands or other invocations 1680 containing one or more pointers to or other identifiers 1681 of one or more selected versions 1876, 1877). This can occur, for example, in a context in which system 330 includes or otherwise implements system 1600 and in which module 1663 transmits the resulting invocation(s) 1680 to storage device 358 or output device 365 in or near region 300. Alternatively or additionally, the resulting invocation(s) 1680 may be provided to a server, router, or other system 340 operable to respond by transmitting at least some of the version(s) 1877 into the region. In some variants, for example, system 340 may be configured to use the identifier(s) to retrieve any identified version(s) not provided with the invocation(s).

With reference now to FIG. 27, there are shown several variants of the flow 200 of FIG. 2 or FIG. 26. Operation 210—obtaining an indication of whether one or more parties in a region can be classified using auditory or optical data—may include one or more of the following operations: 2711, 2714, or 2718. Operation 220—signaling a decision of which version of a message to introduce into the region at least partly based on the indication of whether the one or more parties can be classified using the auditory or optical data—may include one or more of the following operations: 2722, 2723, 2726, or 2727.

Operation 2711 describes receiving at least some of the auditory or optical data from the region (e.g. module 1635 receiving more than one of optical data 132, auditory data 139, or other data 140 from region 190). This can occur, for example, in a context in which region 190 overlaps or abuts one or more sensors as described herein and in which system 1600 implements or otherwise receives such data from system 130. Alternatively or additionally, evaluation module 125 may distill or otherwise provide data 140 derived from an output of sensor module 121, optionally in combination with some input data 122, and optionally via system 130. In some variants, for example, system 120 may provide such data to system 130 (for archiving, for example) and also to system 1600 (e.g. for analysis).

Operation 2714 describes recognizing a specific face in the auditory or optical data (e.g. detection module 1630 invoking module 592 for recognizing the face of user 401 in image data signal 542). This can occur, for example, in a context in which system 1600 implements interface 500 including one or more cameras or other sensors 406 able to receive such an image data signal as optical data. In some variants, for example, this can be done in the absence of auditory data.

Operation 2718 describes receiving one or more party identifiers as the indication of whether the one or more parties can be classified (e.g. detection module 1630 accepting one or more identifiers 1621 or identifier-containing images 1620 from a module 328 for reading or otherwise detecting identification badges 309 of one or more users 301, 302 in region 300). This can occur, for example, in a context in which system 330 may transmit sensor data to some implementation of system 1600 as described herein and in which one or more modules 1631 can authenticate such images 1620 or other identifiers 1621-1622 as being from module 328 and/or of authorized personnel. Alternatively or additionally, one or more such party identifiers 1621 may comprise passwords or other auditory or indirect data. In some variants, for example, a recognized user 301 may provide one or more identifiers 1622 for other parties within region 300 or assert an absence of such parties.

Operation 2722 describes deciding to introduce a specific item into the region only if the one or more parties can be classified (e.g. interaction module 325 invoking module 809 for writing version 333 onto medium 810 only if users 301, 302 can both be classified). This can occur, for example, in a context in which network 390 implements at least some of system 800. Alternatively or additionally, such a transmission can be permissible in a context in which the region contains no people. In some variants, for example, the region of interest may include only solid medium 810 or some other inanimate, solid object(s).

Operation 2723 describes storing at least one version of the message within the region (e.g. interaction module 325 invoking module 321 for requesting or otherwise prompting storage device 358 to store at least version 331 inside region 300). This can occur, for example, in a context in which one or more other versions 332, 333 are presented to the region, such as by output device 320. Alternatively or additionally, such selected versions may be stored in the region. In some variants, for example, such storage inside the region can facilitate later access to non-selected versions, for example, via output device 365.

Operation 2726 describes transmitting at least a portion of the auditory or optical data to a provider of at least some of the message (e.g. interaction module 1650 invoking one or more modules 1662 for transmitting at least an instance 133-137 or segment 138 corresponding thereto to a message composer at system 120). This can occur, for example, in a context in which system 130 can access or otherwise implement system 1600 and in which the auditory and/or optical data obtained via one or more sensors 131 may be of interest to the message composer. Alternatively or additionally, the decision of which version to introduce (into region 190, for example) may be controlled or otherwise influenced by one or more users, for example, who can access system 120. The user(s) may, for example, decide to send or authorize an explicit version of the message, for example, in response to what they perceive about region 190 in light of samples or other distillations of data 140. In some variants, the users may also take into account a current time-of-day or other determinants as described herein and/or may automate such version decisions, for example, in a configuration of module 1662.

Operation 2727 describes deciding upon a version of the message partly based on an apparent physical position of at least one of the one or more parties in the region (e.g. interaction module 325 invoking module 323 for selecting version 1875 for use at output device 1830 in response to an indication 326 that user 302 is apparently not in a position to hear anything from output device). This can occur in a context in which system 300 implements interface 1800 and in which a presence of user 302 inside region 300 would otherwise render version 1875 inappropriate, for example, if user 302 is not recognized as having a security clearance. Alternatively or additionally, a composer or other sender may designate one or more versions (or portions of versions) as being presentable only in the presence of a single individual or classification of individuals. In some variants, for example, a message may include a public or other less-restricted portion that is visible in all versions and a more-restricted portion that is only visible in a version designated for presentation to one or more specific individuals or other narrower classifications. Alternatively or additionally, some versions of a message may include more than one presentable version therein, in some embodiments, so that the appearance of such a version may change real time in response to one or more changes in the constitution(s) or classification(s) of the one or more individuals present in the environment.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those skilled in the art will recognize that it is common within the art to describe devices and/or processes in the fashion set forth herein, and thereafter use engineering practices to integrate such described devices and/or processes into image processing systems. That is, at least a portion of the devices and/or processes described herein can be integrated into an image processing system via a reasonable amount of experimentation. Those having skill in the art will recognize that a typical image processing system generally includes one or more of a system unit housing, a video display device, a memory such as volatile and non-volatile memory, processors such as microprocessors and digital signal processors, computational entities such as operating systems, drivers, and applications programs, one or more interaction devices, such as a touch pad or screen, control systems including feedback loops and control motors (e.g., feedback for sensing lens position and/or velocity; control motors for moving/distorting lenses to give desired focuses. A typical image processing system may be implemented utilizing any suitable commercially available components, such as those typically found in digital still systems and/or digital motion systems.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

Those skilled in the art will recognize that it is common within the art to implement devices and/or processes and/or systems in the fashion(s) set forth herein, and thereafter use engineering and/or business practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, hovercraft, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Quest, Southwestern Bell, etc), or (g) a wired/wireless services entity such as Sprint, Cingular, Nextel, etc.), etc.

One skilled in the art will recognize that the herein described components (e.g., steps), devices, and objects and the discussion accompanying them are used as examples for the sake of conceptual clarity and that various configuration modifications are within the skill of those in the art. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

Although users 301, 302, 401, 1101, 1701 are shown/described herein each as a single illustrated figure, those skilled in the art will appreciate that such users may be representative of a human user, a robotic user (e.g., computational entity), and/or substantially any combination thereof (e.g., a user may be assisted by one or more robotic agents). In addition, each such user, as set forth herein, although shown as a single entity may in fact be composed of two or more entities. Those skilled in the art will appreciate that, in general, the same may be said of “sender” and/or other entity-oriented terms as such terms are used herein.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, those skilled in the art will appreciate that recited operations therein may generally be performed in any order. Examples of such alternate orderings may include overlapping, interleaved, interrupted, reordered, incremental, preparatory, supplemental, simultaneous, reverse, or other variant orderings, unless context dictates otherwise. With respect to context, even terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method comprising:
obtaining an indication of whether one or more parties in a region can be classified using auditory or optical data; and
signaling a decision of which version of a message to introduce into the region at least partly based on the indication of whether the one or more parties can be classified using the auditory or optical data.

2-14. (canceled)

15. A system comprising:
means for obtaining an indication of whether one or more parties in a region can be classified using auditory or optical data; and
means for signaling a decision of which version of a message to introduce into the region at least partly based on the indication of whether the one or more parties can be classified using the auditory or optical data.

16-28. (canceled)

29. A system comprising:
circuitry for obtaining an indication of whether one or more parties in a region can be classified using auditory or optical data; and
circuitry for signaling a decision of which version of a message to introduce into the region at least partly based on the indication of whether the one or more parties can be classified using the auditory or optical data.

30. The system of claim 29 in which the circuitry for obtaining an indication of whether one or more parties in a region can be classified using auditory or optical data comprises:
circuitry for providing at least auditory data of the auditory or optical data to a data processing module operable to apply one or more criteria.

31. The system of claim 29 in which the circuitry for obtaining an indication of whether one or more parties in a region can be classified using auditory or optical data comprises:
circuitry for causing one or more stimuli to enter the region.

32. The system of claim 29 in which the circuitry for obtaining an indication of whether one or more parties in a region can be classified using auditory or optical data comprises:
circuitry for identifying one or more apparent natural-language abilities of at least one of the one or more parties.

33. The system of claim 29 in which the circuitry for signaling a decision of which version of a message to introduce into the region at least partly based on the indication of whether the one or more parties can be classified using the auditory or optical data comprises:
circuitry for deciding upon a version of the message at least partly based on an age indication of at least one of the one or more parties in the region.

34. The system of claim 29 in which the circuitry for signaling a decision of which version of a message to introduce into the region at least partly based on the indication of whether the one or more parties can be classified using the auditory or optical data comprises:
circuitry for deciding upon a version of the message partly based on an apparent state of at least one of the one or more parties in the region.

35. The system of claim 29 in which the circuitry for signaling a decision of which version of a message to introduce into the region at least partly based on the indication of whether the one or more parties can be classified using the auditory or optical data comprises:
circuitry for configuring an invocation to identify the decision of which version of the message to introduce into the region.

36. The system of claim 29 in which the circuitry for obtaining an indication of whether one or more parties in a region can be classified using auditory or optical data comprises:
circuitry for receiving at least some of the auditory or optical data from the region.

37. The system of claim 29 in which the circuitry for obtaining an indication of whether one or more parties in a region can be classified using auditory or optical data comprises:
circuitry for recognizing a specific face in the auditory or optical data.

38. The system of claim 29 in which the circuitry for obtaining an indication of whether one or more parties in a region can be classified using auditory or optical data comprises:
circuitry for receiving one or more party identifiers as the indication of whether the one or more parties can be classified.

39. The system of claim 29 in which the circuitry for signaling a decision of which version of a message to introduce into the region at least partly based on the indication of whether the one or more parties can be classified using the auditory or optical data comprises:
circuitry for deciding to introduce a specific item into the region only if the one or more parties can be classified.

40. The system of claim 29 in which the circuitry for signaling a decision of which version of a message to introduce into the region at least partly based on the indication of whether the one or more parties can be classified using the auditory or optical data comprises:
circuitry for storing at least one version of the message within the region.

41. The system of claim 29 in which the circuitry for signaling a decision of which version of a message to introduce into the region at least partly based on the indication of whether the one or more parties can be classified using the auditory or optical data comprises:
circuitry for transmitting at least a portion of the auditory or optical data to a provider of at least some of the message.

42. The system of claim 29 in which the circuitry for signaling a decision of which version of a message to introduce into the region at least partly based on the indication of whether the one or more parties can be classified using the auditory or optical data comprises:
circuitry for deciding upon a version of the message partly based on an apparent physical position of at least one of the one or more parties in the region.

43. An apparatus comprising:
one or more physical media configured to bear a device-detectable implementation of a method including at least
obtaining an indication of whether one or more parties in a region can be classified using auditory or optical data; and
signaling a decision of which version of a message to introduce into the region at least partly based on the indication of whether the one or more parties can be classified using the auditory or optical data.

44. (canceled)

45. The apparatus of claim 43 in which a portion of the one or more physical media comprises:
one or more signal-bearing media configured to transmit one or more instructions for signaling a decision of which version of a message to introduce into the region at least partly based on the indication of whether the one or more parties can be classified using the auditory or optical data and
one or more signal-bearing media configured to bear at least one of a special-purpose instruction sequence, a special-purpose-circuit design or an information-bearing static attribute as a portion of the device-detectable implementation.

46-62. (canceled)

63. An apparatus comprising:
one or more physical media bearing a device-detectable output indicating an occurrence of
obtaining an indication of whether one or more parties in a region can be classified using auditory or optical data; and
signaling a decision of which version of a message to introduce into the region at least partly based on the indication of whether the one or more parties can be classified using the auditory or optical data.

64. (canceled)

65. The apparatus of claim 63 in which at least one of the one or more physical media comprises:
one or more signal-bearing media transmitting a portion of the device-detectable output at least partly responsive to signaling a decision of which version of a message to introduce into the region at least partly based on the indication of whether the one or more parties can be classified using the auditory or optical data and
a portable module including at least an auditory interface configured to be operated while the portable module is held or worn.

66-82. (canceled)

83. The method of claim 1 in which obtaining an indication of whether one or more parties in a region can be classified using auditory or optical data comprises:
causing one or more stimuli to enter the region;
receiving at least some of the auditory or optical data from the region;
recognizing a specific face in a first portion of the auditory or optical data;
providing at least a second portion of the auditory or optical data to a data processing module operable to identify one or more apparent natural-language abilities of at least one of the one or more parties; and
receiving one or more party identifiers as the indication of whether the one or more parties can be classified.

84. The method of claim 83 in which signaling a decision of which version of a message to introduce into the region at least partly based on the indication of whether the one or more parties can be classified using the auditory or optical data comprises:
deciding upon at least a version of the message to be stored in the region based on one or more of (a) an age indication of or (b) an apparent physical position of at least one of the one or more parties in the region; and
deciding to introduce a specific item into the region only if the one or more parties can be classified.

85. The system of claim 29 in which the circuitry for signaling a decision of which version of a message to introduce into the region at least partly based on the indication of whether the one or more parties can be classified using the auditory or optical data comprises:
circuitry for deciding upon at least a version of the message to store in the region based on one or more of (a) an age indication of or (b) an apparent physical position of at least one of the one or more parties in the region;
circuitry for storing at least one of the one or more versions of the message within the region; and
circuitry for transmitting a portion of the auditory or optical data to a provider of at least some of the message.

86. The system of claim 29 in which the circuitry for obtaining an indication of whether one or more parties in a region can be classified using auditory or optical data comprises:
circuitry for causing one or more stimuli to enter the region;
circuitry for receiving at least some of the auditory or optical data from the region;
circuitry for recognizing a specific face in a first portion of the auditory or optical data;
circuitry for providing at least a second portion of the auditory or optical data to a data processing module operable to identify one or more apparent natural-language abilities of at least one of the one or more parties; and
circuitry for receiving one or more party identifiers as the indication of whether the one or more parties can be classified.

87. The system of claim 86 in which the circuitry for signaling a decision of which version of a message to introduce into the region at least partly based on the indication of whether the one or more parties can be classified using the auditory or optical data comprises:
circuitry for deciding upon at least a version of the message to be stored in the region based on one or more of (a) an age indication of or (b) an apparent physical position of at least one of the one or more parties in the region;
circuitry for deciding to introduce a specific item into the region only if the one or more parties can be classified; and
circuitry for transmitting a third portion of the auditory or optical data to a provider of at least some of the message.
